(19) United States
(12) Patent Application Publication
(10) Pub. No.: US 2008/0167914 A1
(43) Pub. Date: Jul. 10, 2008

(54) Customer Help Supporting System, Customer Help Supporting Device, Customer Help Supporting Method, and Customer Help Supporting Program

(75) Inventors: Takahiro Ikeda, Chiba (JP); Yoshihiro Ikeda, Chiba (JP); Satoshi Nakazawa, Tokyo (JP); Kenji Satoh, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 11/884,921

(22) PCT Filed: Feb. 22, 2006
(86) PCT No.: PCT/JP06/03811

§ 371 Date: Nov. 16, 2007

(30) Foreign Application Priority Data
Feb. 23, 2005 (JP) 2005-046874

(51) Int. Cl. G06Q 10/00; G06F 17/30

(52) U.S. Cl. 705/7; 705/1

(57) ABSTRACT

A customer help supporting device includes an input unit (100) such as a microphone, a data processing unit (200A), a storage unit (300A) such as a hard disk, and an output unit (400) such as a display. The storage unit (300A) has a support information storage section (301) stores support information to be presented to an attendant and a combination of one or more utterance contents the utterers of which are specified. The support information is associated with the combination. The data processing unit (200A) has utterance content temporary holding means (201) for temporarily holding the whole utterance contents sequentially inputted from the time when the conversation relating to the utterance contents starts, utterance content condition matching means (202) for screening the support information to be presented to the attendant only when the utterance contents which are the presentation condition of the support information all match the utterance contents in the utterance content sequence up to the present held in the utterance content temporary holding means (201), and support information output means (203) for outputting the support information to the output unit (400). The support information to be presented to the attendant and the presentation timing are minutely controlled depending on the progress of the utterance contents.

### TECHNICAL FIELD

The present invention relates to an interaction assistance system, interaction assistance apparatus, interaction assistance method and interaction assistance program which assist a receptionist in interacting with a customer through a communication line. More particularly, the present invention relates to an interaction assistance system, interaction assistance apparatus, interaction assistance method and interaction assistance program which assist a receptionist in interacting with a customer by presenting assistance information.

### BACKGROUND ART

A typical related interaction assistance system of this kind is configured to enable a receptionist to efficiently reference pre-compiled information. Examples of related interaction assistance system are those disclosed in Japanese Patent Laying-Open No. 2003-23498 (Literature 1) and Japanese Patent Laying-Open No. 2003-208439 (Literature 2).

The interaction assistance apparatus disclosed in Literature 1 first presents to a receptionist who is interacting with a customer through a telephone call a plurality of identification names corresponding to the current interaction content and then presents the receptionist with an interaction content associated with the identification name selected by the receptionist. An interaction content contains a comment to be made and an action to be taken by the receptionist and is previously stored in a database, together with an identification name which is previously assigned to the interaction content. The receptionist can select an identification name and reference the corresponding interaction content by following a simple procedure.

The conversation response assistance system disclosed in Literature 2 voice-recognizes a conversation ongoing between a receptionist and a customer and extracts a keyword from the content of the conversation. It then retrieves candidate response information associated with that keyword and presents the results to the receptionist. Candidate response information is previously recorded in a recording apparatus. The receptionist can reference the information associated with the immediately preceding content of the conversation with the customer from the pre-compiled candidate response information, without having to perform special operations.

These and other related interaction assistance systems have problems as described below. The first problem is the inability to present appropriate assistance information to a receptionist according to the progress of a conversation taking place between the receptionist and a customer via phone or other means.

For example, suppose a situation in which a customer has applied for both a service A and a service B and it is desirable to instruct the receptionist to ask the customer whether he/she would like to apply for an optional service S. If the customer has applied for both the services A and B during the current conversation between the receptionist and the customer, the assistance information which is desirably presented to the receptionist is one which prompts the receptionists to ask the customer whether he/she would like to apply for the optional service S, regardless of the order in which the services A and B have been applied for or regardless of the time interval from the application of one service to the application of the other. On the other hand, if the customer has applied for one of the services A and B, instead of both, assistance information related to the optional service is desirably not presented to the receptionist even though both the services A and B are mentioned during the conversation. Related interaction assistance systems, however, are not capable of presenting an appropriate amount and kind of assistance information at appropriate timings.

This is because related interaction assistance systems do not use the occurrence of some specific interactions in the content of the conversation heretofore between the receptionist and the customer as an assistance information presentation condition.

For example, the system disclosed in Literature 1 presents the receptionist with assistance information according to his/her selection of a corresponding identification name. In order to ensure the presentation of appropriate assistance information, the receptionist must carefully select the right identification name.

The system disclosed in Literature 2 retrieves and presents the receptionist with all the information related to the content of the conversation heretofore between the receptionist and the customer, which leads to a higher likeliness that unnecessary information is presented to the receptionist as assistance information. For example, in the situation above, a mere mention of the service A and the service B will trigger the system to present assistance information concerning an application for the optional service S.

The second problem is that the system requires assistance information to be previously prepared for presentation to receptionists. Assistance information must be written and compiled to ensure quick understanding by receptionists, which can very often be onerous and time-consuming. If the content of a conversation between the receptionist and the customer differs from what was assumed during the preparation of the assistance information, the system can be of no assistance to the receptionist.

This is because a related interaction assistance system typically requires that assistance information for receptionists be already stored in a storage apparatus and because the system is not provided with the capabilities to automatically collect and update assistance information.

The third problem is that assistance is inadequate for a receptionist who is interacting with a customer with a specific purpose in mind.

For example, a front window receptionist who is responsible for accepting cancellations of services may interact with a customer for the purpose of persuading the customer to withdraw his/her request for cancellation of a service. In this case, the purpose is achieved if the customer ultimately withdraws his/her request for cancellation, and is not achieved if the customer ultimately cancels the service. If factors for cancellation withdrawal by the customer exist in the content of the conversation between the receptionist and the customer, then presenting in advance such factors to the receptionist will assist the receptionist in interacting with the customer in a manner which is effective to persuade the customer to withdraw the cancellation request. However, with related interaction assistance systems, it is not possible to present assistance information which can assist a receptionist in achieving a specific purpose, unless factors for cancellation withdrawal by customers have been identified by analysis, documented and stored as assistance information.

This is because a related interaction assistance system typically undiscriminately collects and accumulates conversations in which their purposes were achieved and not achieved and because it does not have any means to identify conversations of a nature which can largely contribute to the achievement of a specific purpose.

### SUMMARY

A first exemplary object of the present invention is to provide an interaction assistance system which can present a receptionist with appropriate assistance information according to the progress of an interaction taking place between the receptionist and a customer.

A second exemplary object of the present invention is to provide an interaction assistance system which presents to a receptionist assistance information based on past interaction contents as well as histories of references to other data, without the necessity to previously prepare assistance information.

A third exemplary object of the present invention is to provide an interaction assistance system which accumulates past interaction contents and their interaction results with respect to success or failure in achieving their purposes and which presents to a receptionist who is interacting with a customer for a specific purpose assistance information indicating the most effective method of interaction to achieve that purpose.

According to a first exemplary aspect of the invention, an interaction assistance system which assists a receptionist in interacting with a customer, includes an assistance information storage server which stores prior knowledge to help the receptionist perform an interaction with the customer smoothly, and an assistance information presentation apparatus which, when the receptionist interacts with the customer, analyzes the content of the interaction performed between the receptionist and the customer, acquires the prior knowledge associated with the content of the response from the assistance information storage server, and presents to the receptionist such knowledge as assistance information to assist the receptionist in responding to the customer.

According to a second exemplary aspect of the invention, an interaction assistance system which assists a receptionist in interacting with a customer via a communication line, includes an assistance information storage server which, as assistance information to assist the receptionist in interacting with the customer, stores and accumulates the content of the interaction performed between the receptionist and the customer via the communication line, in association with order information which indicates the order relation within the interaction content, and an assistance information presentation apparatus which, based on the content of the interaction which is currently being performed with the customer via the communication line, acquires from the assistance information storage server the content of the interaction indicated by the order information as a candidate of the interaction content to be spoken following the content of the interaction which is currently being performed, and presents such content to the receptionist as the assistance information.

According to a third exemplary aspect of the invention, an interaction assistance system which assists a receptionist in interacting with a customer via a communication line, includes an assistance information storage server which, as assistance information to assist the receptionist in interacting with the customer, stores the reference information referenced by the receptionist as of the time of the content of the interaction with the customer, in association with the content of the interaction, and an assistance information presentation apparatus which acquires from the assistance information storage server the reference information associated with the content of the interaction which is currently being performed with the customer via the communication line, and presents such information to the receptionist as the assistance information.

According to a fourth exemplary aspect of the invention, an interaction assistance system which assists a receptionist in interacting with a customer via a communication line, includes an assistance information storage server which, as assistance information to assist the receptionist in interacting with the customer, stores the interaction evaluation information which indicates the result of the interaction produced by the content of the interaction performed between the receptionist and the customer, in association with the content of the interaction, and an assistance information presentation apparatus which acquires from the assistance information storage server the interaction evaluation information associated with the content of the interaction which is currently being performed with the customer via the communication line, and presents such information to the receptionist as assistance information.

### BRIEF DESCRIPTION OF THE DRAWINGS

FIG. 1 is a block diagram showing a functional configuration of an interaction assistance apparatus 10A according to a first exemplary embodiment of the present invention;

FIG. 2 is a block diagram showing a hardware configuration of the interaction assistance apparatus 10A according to the first exemplary embodiment of the present invention;

FIG. 3 is a block diagram showing a configuration of an interaction assistance system 500 having as a component thereof the interaction assistance apparatus 10A according to the first exemplary embodiment of the present invention;

FIG. 4 is a flow chart showing the operation of the interaction assistance apparatus 10A according to the first exemplary embodiment of the present invention;

FIG. 5 is a block diagram showing a configuration of an interaction assistance apparatus 10B according to a second exemplary embodiment of the present invention;

FIG. 6 is a flow chart showing the operation of the interaction assistance apparatus 10B according to the second exemplary embodiment of the present invention;

FIG. 7 is a block diagram showing a configuration of an interaction assistance apparatus 10C according to a third exemplary embodiment of the present invention;

FIG. 8 is a flow chart showing the operation of the interaction assistance apparatus 10C according to the third embodiment of the present invention;

FIG. 9 is a block diagram showing a configuration of an interaction assistance apparatus 10D according to a fourth exemplary embodiment of the present invention;

FIG. 10 is a flow chart showing the operation of the interaction assistance apparatus 10D according to the fourth exemplary embodiment of the present invention;

FIG. 11 is a block diagram showing a configuration of an interaction assistance apparatus 10E according to a fifth exemplary embodiment of the present invention;

FIG. 12 is a diagram showing assistance information and presentation conditions according to a first example of the present invention;

FIG. 13 is a diagram showing an utterance content column between a receptionist and a customer, according to the first example of the present invention;

FIG. 14 is a diagram showing utterance contents which are regarded to be of the same type, according to the first example of the present invention;

FIG. 15 is a diagram showing utterance content histories according to second and third examples of the present invention;

FIG. 16 is a diagram showing the utterance content column between a receptionist and a customer, according to the second and third examples of the present invention;

FIG. 17 is a diagram showing utterance contents which are regarded to be of the same type, according to the second and third examples of the present invention;

FIG. 18 is a diagram showing utterance content histories according to the second example of the present invention;

FIG. 19 is a diagram showing reference histories according to the third example of the present invention;

FIG. 20 is a diagram showing utterance content histories according to a fourth example of the present invention;

FIG. 21 is a diagram showing utterance content column evaluation values according to the fourth example of the present invention;

FIG. 22 is a diagram showing an utterance content column between a receptionist and a customer, according to the fourth example of the present invention;

FIG. 23 is a diagram showing utterance contents which are regarded to be of the same type, according to the fourth example of the present invention; and

FIG. 24 is a diagram showing utterance content histories according to the fourth example of the present invention.

### EXEMPLARY EMBODIMENT

Hereinafter, exemplary embodiments of the invention will be described in detail referring to the drawings.

### First Exemplary Embodiment

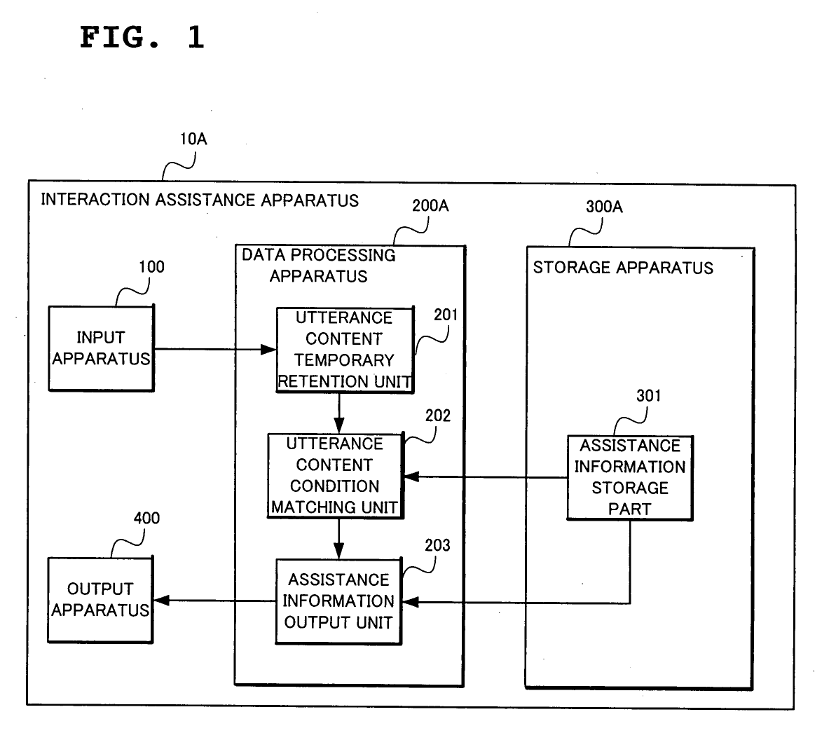

FIG. 1 is a block diagram showing a functional configuration of an interaction assistance apparatus 10A, which is a first exemplary embodiment of the present invention.

With reference to FIG. 1, an interaction assistance apparatus 10A is an interaction assistance apparatus which assists a receptionist in interacting with a customer via a communication line (e.g., a telephone line), and comprises an input apparatus 100; a data processing apparatus 200A which operates under program control; a storage apparatus 300A which stores information, such as a hard disc and a memory; and an output apparatus 400, such as a display apparatus.

The input apparatus 100 is an apparatus through which to input an utterance contents (interaction content) during an interaction between a customer and a receptionist via a communication line. Examples include a microphone through which to input an utterance content when a receptionist speaks, and a telephone line interface apparatus through which to input an utterance content when a customer speaks via a communication line. The input apparatus 100 also includes apparatuses through which to manually or orally input data into the data processing apparatus 200A, such as a keyboard, a mouse and a microphone, and apparatuses through which to input data from an external medium, such as a network interface apparatus and an external storage interface apparatus.

The storage apparatus 300A comprises an assistance information storage part 301.

The assistance information storage part 301 previously stores one or more utterance content sets, in each of which utterance contents spoken by the speakers, i.e., a customer and a receptionist, have been identified, along with their associated assistance information to be presented to the receptionist. Each utterance content set associated with assistance information is used as a presentation condition to determine whether or not a particular piece of assistance information should be presented to the receptionist.

Assistance information herein means a prior knowledge that a receptionist should have in order to ensure smooth progress of an interaction with a customer. Examples of prior knowledge include precautions which must be taken by receptionists during interactions, explanations of the procedure to be followed by receptionists as they proceed with an interaction, instructions concerning the contents of utterances to be spoken to customers, and complementary information to help receptionists understand utterances of customers.

For example, suppose there is a piece of assistance information “Confirm whether or not the customer will apply for an optional service C.” As a presentation condition for this assistance information, an utterance content set may be stored which consists of two utterance contents: one in which the speaker is a “customer” and the utterance content is “I would like to apply for the service A” and the other in which the speaker is a “customer” and the utterance content is “I would like to apply for the service B.” By storing a piece of assistance information along with its associated presentation condition as described above, it becomes possible to present a receptionist with the piece of assistance information “Confirm whether or not the customer will apply for an optional service C” if a customer makes an utterance whose content is “I would like to apply for the service A” and if the customer also makes an utterance whose content is “I would like to apply for the service B.”

The data processing apparatus 200A comprises an utterance content temporary retention unit 201, an utterance content condition matching unit 202, and an assistance information output unit 203.

The utterance content temporary retention unit 201 accepts inputs of utterance contents which comprise an interaction content (an utterance content column) as they occur during an interaction between a receptionist and a customer, and temporarily retains the entire utterance content column covering from the utterance content at the start of the interaction between the receptionist and the customer and up to the utterance content of the newest utterance in the same interaction.

In the utterance content column herein, the two parties do not necessarily have to appear as the speaker in a strictly alternate manner, but may be the speaker of two or more consecutive utterance contents in the column.

If a receptionist serves a customer in a voice interaction by telephone or IP telephone, a voice recognition apparatus (not shown) can be used to convert utterance into text data and retain the results as utterance contents. Furthermore, in addition to directly using the utterances of the customer him/herself, it is possible to extract the part of the receptionist's utterances corresponding to repetitions of the contents spoken by the customer and use such part as the customer's utterance contents.

If a receptionist serves a customer through a bulletin board or chat system over a communication network, text data of interactions between the receptionist and the customer can be retained as utterance contents.

The utterance content temporary retention unit 201 does not require utterance contents to be represented as text data only, but can retain them in a more appropriate structure to represent utterance contents, such as a syntax structure, text data with voice information, and a plurality of candidate voice recognition results. This also applies to utterance contents stored as assistance information presentation conditions.

The utterance content condition matching unit 202 determines whether or not any of the utterance contents which are stored in the assistance information storage part 301 as assistance information presentation conditions is contained in the utterance content column heretofore which are stored in the utterance content temporary retention unit 201. More specifically, the utterance content condition matching unit 202 determines whether or not any of the utterance contents stored as assistance information presentation conditions is contained in the interaction content heretofore between the receptionist and the customer (utterance content column) and selects a particular piece of assistance information at the time when all of the utterance contents defined as presentation conditions are contained in the utterance content column heretofore for the first time and not other times.

The degree of similarity between sentences, which is commonly used in information retrieval and other similar technologies, is used to determine whether or not an utterance content actually spoken is the same as an utterance content defined as a presentation condition. For example, an utterance content pair whose degree of similarity is equal to or higher than a particular value may be regarded to be the same utterance contents. One example of factors for determining the degree of similarity is the number of keywords which commonly appear.

The assistance information output unit 203 outputs the assistance information selected by the utterance content condition matching unit 202 onto the output apparatus 400 to present to the receptionist.

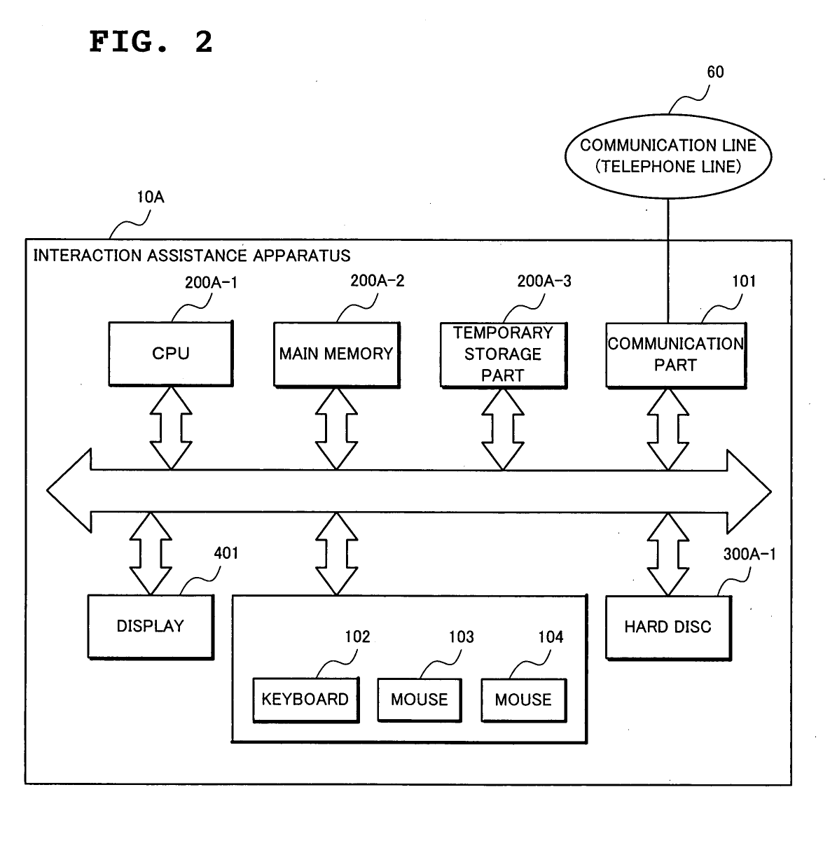

FIG. 2 is a block diagram showing a hardware configuration of the interaction assistance apparatus 10A according to the first exemplary embodiment of the present invention.

Referring to FIG. 2, the interaction assistance apparatus 10A comprises as the components of its hardware configuration: a communication part 101; a keyboard 102; a mouse 103; a microphone 104; a CPU 200A-1 which implements the functions of the utterance content condition matching unit 202 and the assistance information output unit 203 via program control; a storage apparatus 300A-1, such as a hard disc apparatus, which functions as the assistance information storage part 301 to store assistance information; a main memory 200A-2 in which an interaction assistance program 50 is loaded and retained; a temporary storage part 200A-3, which functions as the utterance content temporary retention unit 201; and a display 401.

The communication part 101 functions as the utterance content condition matching unit 202 and accepts matching conditions which are transmitted from another equipment (e.g., terminal) via a communication line.

The keyboard 102 and the mouse 103 also function as the utterance content condition matching unit 202 and are used to directly input matching conditions by user's operation. The microphone 104 is used to directly input the contents of utterances spoken by a receptionist when interacting with a customer.

The CPU 200A-1 is a device which provides the functions of the utterance content condition matching unit 202 and the assistance information output unit 203 mentioned above by executing an interaction assistance program (application) 50 which provides these functions and which is stored in a nonvolatile memory or the storage apparatus 300A-1.

As for the characteristic function of the present invention to store pieces of assistance information to assist receptionists in interacting with customers along with their associated predetermined presentation conditions and, if an interaction content between a receptionist and a customer taking place via a communication line satisfies a presentation condition, to retrieve a piece of assistance information corresponding to the presentation condition and instruct such piece of assistance information to be presented to the receptionist, it is possible to realize such function by storing the interaction assistance program (application) 50, which is a program (application) designed to realize the functions that characterize the present invention, in the nonvolatile memory or the storage apparatus 300A-1, loading the program onto the main memory 200A-1, and executing the program by the CPU 200A-1, in addition to implementing the function in hardware by implementing a circuit component incorporating a program which realizes such function.

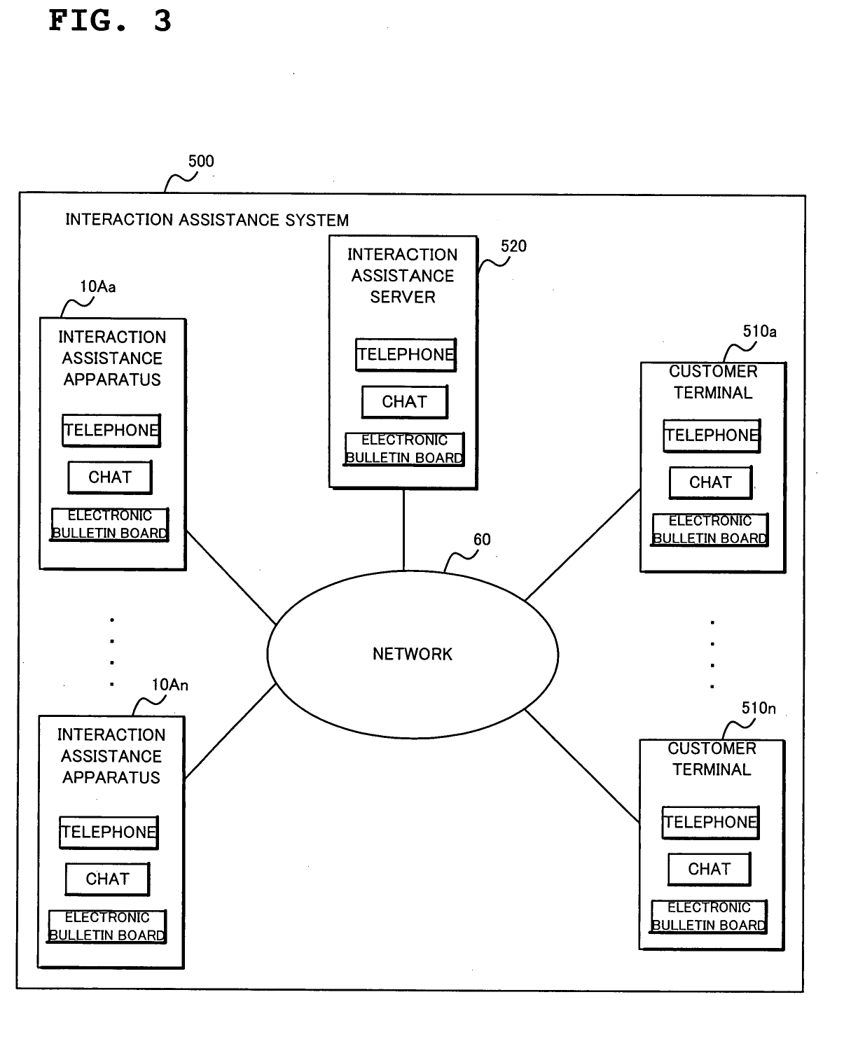

FIG. 3 is a block diagram showing a configuration of an interaction assistance system 500 having as a component thereof the interaction assistance apparatus 10A, which is the first exemplary embodiment of the present invention.

As shown in FIG. 3, the interaction assistance system 500 uses an interaction assistance server 520 to connect between one or more interaction assistance apparatuses 10Aa to 10An and one or more customer terminals 510a to 510n via a network 60.

The interaction assistance server 520 stores pieces of assistance information to assist receptionists in interacting with customers with their associated predetermined presentation conditions and, if an interaction content taking place between a receptionist and a customer through a telephone, an electronic bulletin board, chat or other means over a communication line satisfies one of the stored presentation conditions, extracts the appropriate piece of assistance information which corresponds to the presentation condition and presents it to the receptionist on a real-time basis.

The interaction assistance server 520 may receive utterance contents spoken by receptionists and customers in phone conversations received from the interaction assistance apparatuses 10Aa to 10An and the customer terminals 510a to 510n and store the utterance contents as voice data or otherwise convert the voice data into text data using an audio recognition apparatus.

If a receptionist and a customer interact with each other through an electronic bulletin board or chat system, then communication data may be input into the interaction assistance server 520 as text data.

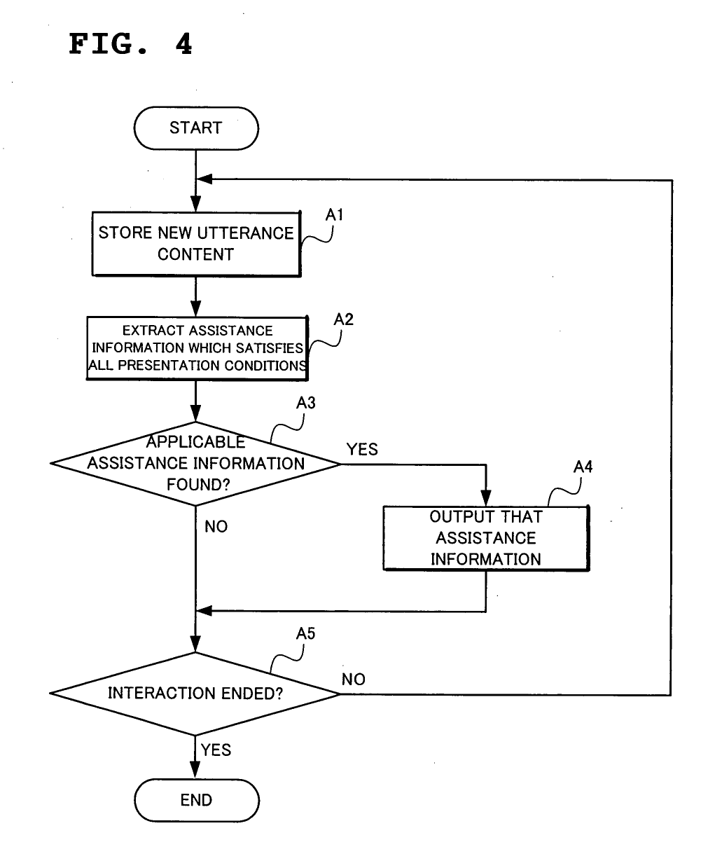

The operation of the interaction assistance apparatus 10A will now be described in detail by referring to FIGS. 1 and 4.

FIG. 4 is a flow chart showing the operation of the interaction assistance apparatus 10A.

Utterance contents which comprises an interaction content (utterance content column) of an interaction between a receptionist and a customer is input through the input apparatus 100 and supplied to the utterance content temporary retention unit 201 in a sequential manner. The utterance content temporary retention unit 201 adds a newly supplied utterance content to previous utterance contents and retains them together (step A1).

The utterance content condition matching unit 202 then checks each of the utterance contents temporarily retained in the utterance content temporary retention unit 201 against each of the assistance information presentation conditions which are stored in the assistance information storage part 301, and extracts only the piece of assistance information all of whose presentation conditions have been satisfied by the current utterance content for the first time (step A2). In the process of extracting an utterance content from the current interaction content (utterance content column) between a receptionist and a customer, a piece of assistance information is not extracted if all of its presentation conditions have already been satisfied by a previous utterance content.

If an applicable piece of assistance information is found in step A2, the assistance information output unit 203 outputs that piece of assistance information (steps A3 and A4).

In addition, if the next utterance content is supplied to the utterance content temporary retention unit 201, the interaction assistance apparatus returns to step A1 and repeats the processing thereafter (step A5).

While this exemplary embodiment has been described using an example in which a piece of assistance information stored in the assistance information storage part 301 is presented to a receptionist for the first time on condition that all of one or more utterance contents whose speakers and their utterance contents have been identified as assistance information presentation conditions appear in the utterance content column heretofore and are stored in the utterance content temporary retention unit 201, it is also possible to form a set of an utterance content spoken by a receptionist and an immediately subsequent utterance content spoken by a customer (i.e., a question content by a receptionist and its response content by a customer) or a set of an utterance content spoken by a customer and an immediately subsequent utterance content by a customer (i.e., a question content by a customer and its response content by a receptionist) and define a condition that such utterance content sets must appear in succession. Non-occurrence of a particular utterance content, occurrence of two or more utterance contents in a particular order, any combination thereof and so on may also be defined as conditions.

Moreover, when determining whether or not any of the assistance information presentation conditions stored in the assistance information storage part 301 is satisfied, it is possible to limit the scope of comparison to an adequate amount of utterance contents taken from more recent utterance contents and ignore older ones, instead of comparing all the utterance contents stored in the utterance content temporary retention unit 201.

The effects of this exemplary embodiment will now be described.

This exemplary embodiment can determine whether or not to present a particular piece of assistance information to a receptionist according to whether or not a specific utterance content spoken by a specific speaker exists in an interaction content heretofore. It is therefore possible to present a receptionist with assistance information in a more finely controlled manner according to the progress of the current interaction content.

This exemplary embodiment presents to a receptionist a piece of assistance information only when all the presentation conditions associated with that piece of assistance information are satisfied for the first time. It is therefore possible to more finely control the timing at which assistance information is presented to the receptionist according to the progress of the current interaction content.

### Second Exemplary Embodiment

An interaction assistance apparatus 10B, which is a second exemplary embodiment of the present invention, will now be described in detail by referring to the drawings.

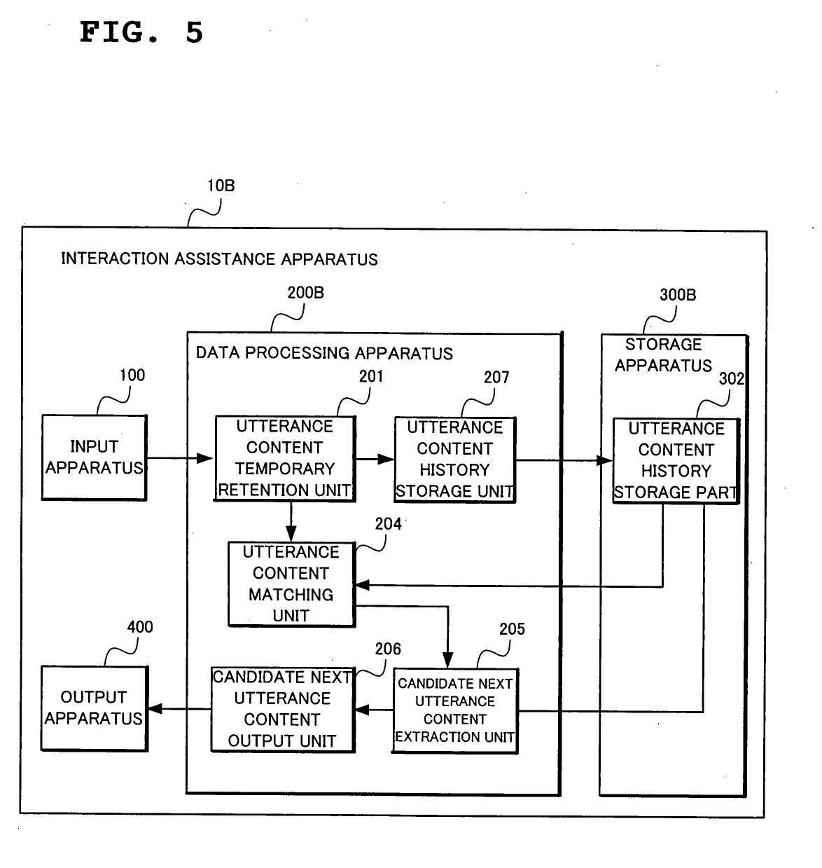

FIG. 5 is a block diagram showing a functional configuration of the interaction assistance apparatus 10B.

With reference to FIG. 5, the interaction assistance apparatus 10B differs from the interaction assistance apparatus 10A of the first exemplary embodiment in that the data processing apparatus 200B replaces the utterance content condition matching unit 202 and the assistance information output unit 203 in the configuration of the data processing apparatus 200A of the first exemplary embodiment shown in FIG. 1 with an utterance content matching unit 204, a candidate next utterance content extraction unit 205, a candidate next utterance content output unit 206, and an utterance content history recording unit 207, and in that the storage apparatus 300B replaces the assistance information storage part 301 in the configuration of the storage apparatus 300A of the first exemplary embodiment shown in FIG. 1 with an utterance content history storage part 302.

The utterance content history storage part 302 stores the entire interaction content (utterance content column) of an interaction heretofore between a receptionist and a customer. An utterance content column consists of one or more sets of a speaker and his/her utterance content.

The utterance content matching unit 204 compares the utterance content column, which consists of utterance contents spoken by a receptionist and a customer heretofore, retained in the utterance content temporary retention unit 201 against each of the past utterance content columns between receptionists and customers stored in the utterance content history storage part 302 to determine the degree of similarity between the current utterance contents and each of the past utterance contents, and based on the results, judges whether or not these utterance content columns correspond to each other.

As a basic rule, if a portion of the utterance contents of the current interaction between a receptionist and a customer from the one at the start to the newest one consecutively occur in the same order as a portion of the past utterance contents stored in the utterance content history storage part 302, then the current utterance content column and the past utterance content column are regarded to correspond to each other. Note that the condition for the current utterance content and a past utterance content to be regarded to correspond to each other may be made less stringent so that these utterance contents can be regarded to correspond to each other despite the presence of a few minor discrepancies. For example, the current utterance content column may be regarded to correspond to a past utterance content column when an utterance content in the current utterance content column does not correspond to any of the utterance contents in the past utterance content column or when the utterance contents which occur consecutively in the current utterance content column do not occur consecutively in the past utterance content column. Furthermore, instead of beginning the current-past correspondence from the start of the current interaction, an appropriate scope of more recent utterance contents in the current utterance content column, including the newest one, may be checked for correspondence with a past utterance content column.

When determining the identity of two different utterance contents, the degree of similarity between sentences which is commonly used in information retrieval and other similar technologies, may be used. For example, two utterance contents may be regarded to be the same if their degree of similarity is equal to or higher than a certain value.

The candidate next utterance content extraction unit 205 retrieves utterance contents stored in a past utterance content column at positions immediately following the past utterance content which has been associated by the utterance content matching unit 204 with the newest utterance content (i.e., an utterance content the most recently retained by the utterance content temporary retention unit 201 among all the utterance contents in this unit) from the utterance content history storage part 302 as candidates of an utterance content which should or may be spoken immediately after the newest utterance content, and extracts the most representative utterance content as a candidate next utterance content.

The candidate next utterance content output unit 206 presents the candidate next utterance content extracted by the candidate next utterance content extraction unit 205 to the receptionist through the output apparatus 400 as a candidate response for the receptionist (if the receptionist is the next speaker) or a next anticipated utterance content for the customer (if the customer is the next speaker).

The utterance content history recording unit 207 records, in the utterance content history storage part 302, utterance content histories from the start to the end of the interaction (utterance content column) retained in the utterance content temporary retention unit 201.

The operation of the interaction assistance apparatus 10B will now be described in detail referring to the drawings.

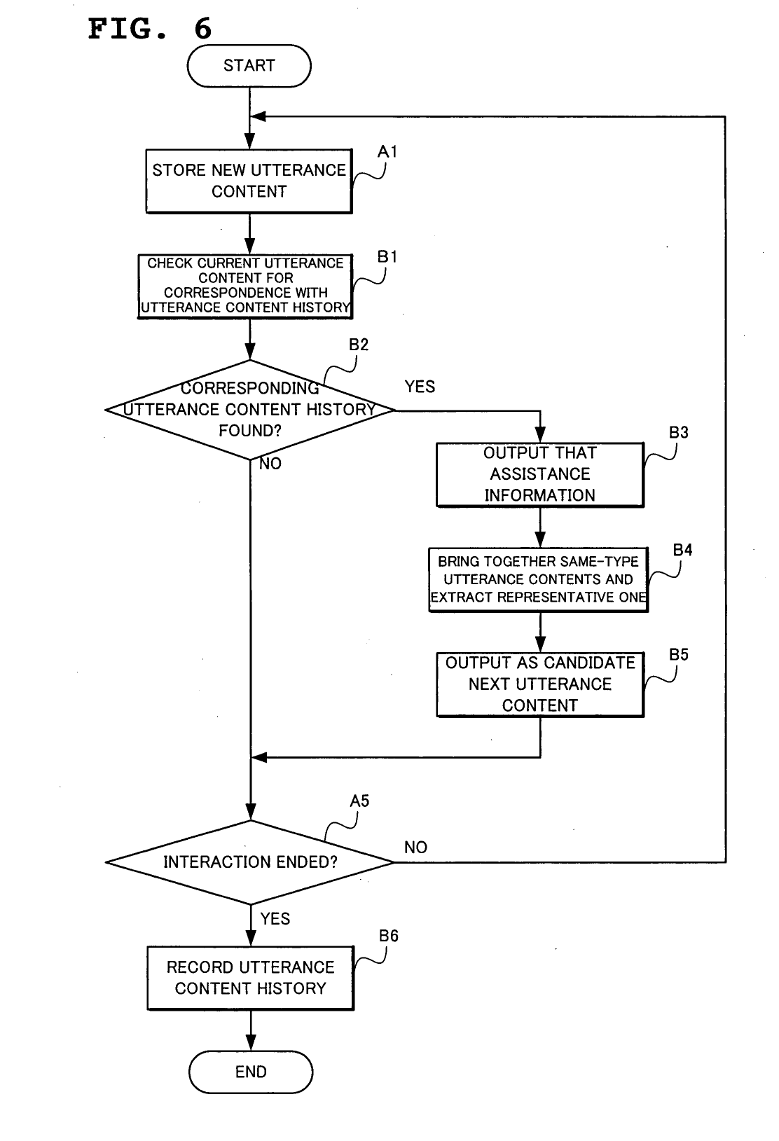

FIG. 6 is a flow chart showing the operation of the interaction assistance apparatus 10B.

The operation of the utterance content temporary retention unit 201 of this exemplary embodiment, shown as steps A1 and A5 in FIG. 6, is omitted from the description below because it is the same as the operation of the utterance content temporary retention unit 201 of the first exemplary embodiment.

In this exemplary embodiment, following step A1, the utterance content matching unit 204 compares the utterance contents in the current utterance content column retained in the utterance content temporary retention unit 201 against the utterance contents in each of the past utterance content columns stored in the utterance content history storage part 302 to determine correspondence between the newest utterance content in the current interaction with each of the past utterance contents (step B1).

If a past utterance content is found to correspond to the newest utterance content, the candidate next utterance content extraction unit 205 retrieves the utterance content stored immediately following the past utterance content corresponding to the newest utterance content from the utterance content history storage part 302 (steps B2 and B3).

If there is more than one utterance content retrieved, the candidate next utterance content extraction unit 205 brings together those utterance contents that can be regarded to be of the same type into one and extracts from this group of somewhat differing utterance contents the most representative one as a candidate next utterance content (step B4). The identity of these utterance contents with the newest one can be determined by the same method used by the utterance content matching unit 204.

The candidate next utterance content output unit 206 then outputs the candidate next utterance content extracted by the candidate next utterance content extraction unit 205 for presentation to the receptionist (step B5).

On completion of the interaction between the receptionist and the customer, the utterance content history recording unit 207 stores the entire interaction content (utterance content column) from the start to the end of the interaction in the utterance content history storage part 302 (step B6).

While this exemplary embodiment has been described using an example in which the candidate next utterance content extraction unit 205 brings together those of the past utterance contents that may be spoken immediately following the newest utterance content and that can be regarded to be of the same type into one, the bringing together process by the candidate next utterance content extraction unit 205 may be omitted and instead a configuration may be adopted in which the utterance content history storage part 302 brings together and retains past utterance contents of the same type in advance when recording utterance content histories or non-synchronously with the progress of an interaction through a preliminary process.

The effects of the second exemplary embodiment will now be described.

This exemplary embodiment can present a receptionist with information as to what utterance content is stored in a past utterance content column formed with utterance contents column equivalent to those in the current utterance content column, as a candidate next utterance content that should or may be spoken following the newest utterance content. It is therefore possible to assist a receptionist without needing to previously prepare assistance information.

### Third Exemplary Embodiment

An interaction assistance apparatus 10C, which is a third exemplary embodiment of the present invention, will now be described in detail by referring to the drawings.

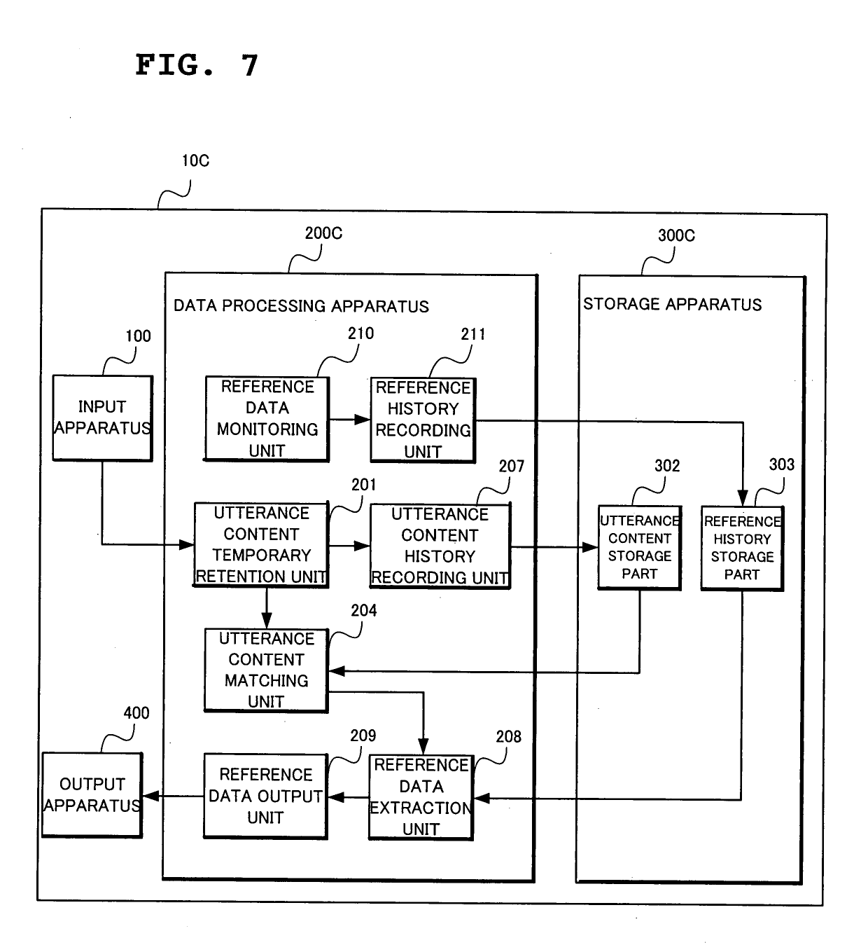

FIG. 7 is a block diagram showing a functional configuration of the interaction assistance apparatus 10C.

With reference to FIG. 7, the interaction assistance apparatus 10C differs from the interaction assistance apparatus 10B of the second exemplary embodiment in that the data processing apparatus 200C replaces the candidate next utterance content extraction unit 205 and the candidate next utterance content output unit 206 in the configuration of the data processing apparatus 200B of the second exemplary embodiment shown in FIG. 5 with a reference data extraction unit 208, a reference data output unit 209, a reference data monitoring unit 210, and a reference history recording unit 211, and in that the storage apparatus 300C has a reference history storage part 303 in addition to the configuration of the storage apparatus 300B of the second exemplary embodiment shown in FIG. 5.

The reference history storage part 303 stores information related to the data referenced by a receptionist during an interaction between the receptionist and a customer heretofore, in association with the utterance content as of the time of referencing the data.

Information related to the data referenced by a receptionist herein refers to information which will become necessary when referencing the same data later again. Examples of such information include an URL, and a set of a document's filename and a page number.

The reference data extraction unit 208 retrieves from the reference history storage part 303 information related to the data referenced by the receptionist as of the time of each past utterance content corresponding to the newest utterance content (the most recently retained utterance content among all the utterance contents retained in the utterance content temporary retention unit 201), based on each of the past utterance contents in the past utterance content column extracted by the utterance content matching unit 204. The reference data extraction unit 208 then selects, for example, more frequently referenced data as the representative data, from the data acquired because of having been referenced by receptionists as of the times of utterance contents.

The reference data output unit 209 acquires the body of the data selected by the reference data extraction unit 208 and presents it to the receptionist by outputting it onto the output apparatus 400.

The reference data monitoring unit 210 monitors as to which data a receptionist references at which point in the progress of an interaction with a customer and stores information concerning which data was referenced at which point in which utterance content.

At the end of an interaction, the reference history recording unit 211 stores in the reference history storage part 303 the information stored by the reference data monitoring unit 210, in association with the utterance content histories stored by the utterance content history recording unit 207 in the utterance content history storage part 302.

The operation of the interaction assistance apparatus 10C will now be described in detail referring to the drawings.

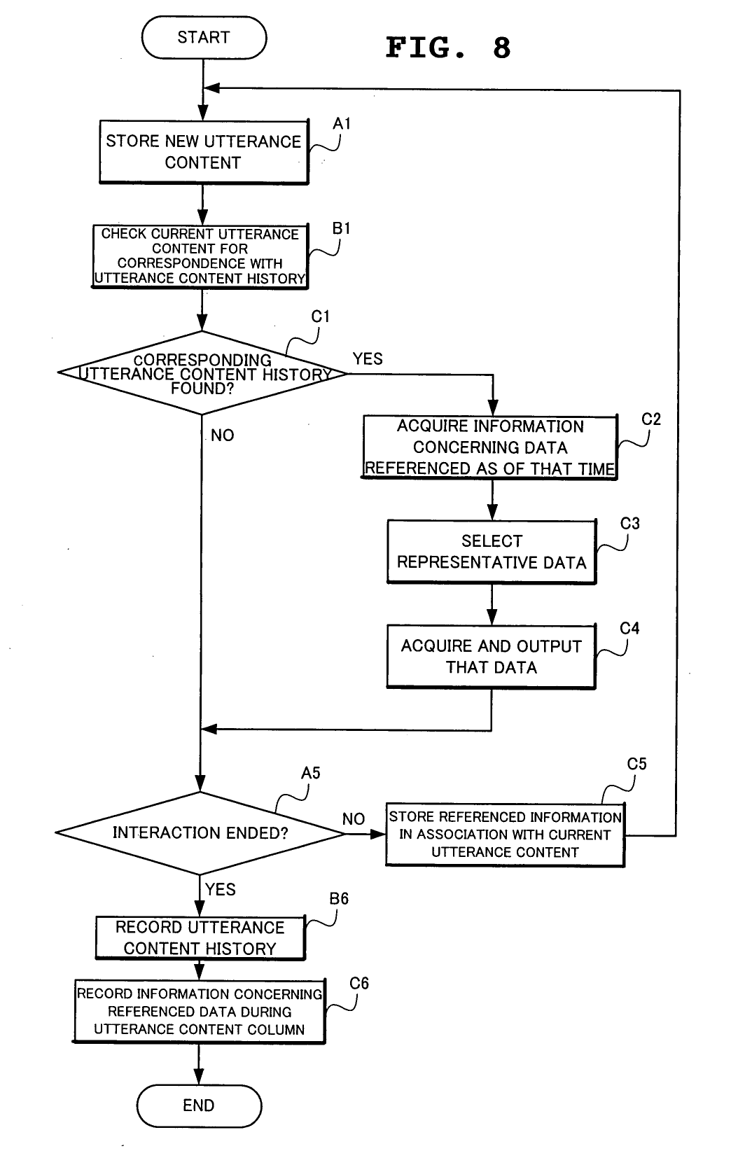

FIG. 8 is a flow chart showing the operation of the interaction assistance apparatus 10C.

The operations of the utterance content temporary retention unit 201, the utterance content matching unit 204, and the utterance content history recording unit 207 of this exemplary embodiment, shown as steps A1, B1, A5, and B6 in FIG. 8, are omitted from the description below because they are the same as the operation of the units 201, 204, and 207 of the first and second exemplary embodiments.

In step B1 of the third exemplary embodiment, if a past utterance content column is found which corresponds to the current utterance content column, the reference data extraction unit 208 acquires from the reference history storage part 303 information related to the data referenced by receptionists as of the times of the past utterance contents which correspond to the newest utterance content (steps C1 and C2).

The reference data extraction unit 208 then selects a representative data among those referenced by receptionists as of the times of the past utterance contents which correspond to the newest utterance content (step C3) based on the acquired information.

Then, the reference data output unit 209 acquires the body of the data selected by the reference data extraction unit 208 and presents it to the receptionist (step C4).

In this exemplary embodiment, the reference data monitoring unit 210 continuously monitors as to which data is referenced by each receptionist. When the receptionist proceeds to the next utterance content to be added to the interaction content (utterance content column), the reference data monitoring unit 210 stores information related to the data referenced by the receptionist as of the time of the newest utterance content in association with the newest utterance content (step C5).

When the interaction ends, the reference history recording unit 211 records the information stored by the reference data monitoring unit 210 in the reference history storage part 303 (step C6).

While this exemplary embodiment has been described using an example in which the reference data output unit 209 acquires the bodies of all the data selected by the reference data extraction unit 208 to present to the receptionist, it may be configured such that the reference data output unit 209 first presents the receptionist with only the information related to each data or only a part of each data (e.g., the subject) and presents the entire body of only the data selected by the receptionist.

Similarly to the second exemplary embodiment, this exemplary embodiment may be configured such that the utterance content history storage part 302 brings together and retains past utterance contents of the same type in advance when recording utterance content histories or non-synchronously with the progress of an interaction through a preliminary process. During this process, the reference history storage part 303 may also store reference histories in association with the utterance contents which have been brought together.

The effects of the third exemplary embodiment will be described below.

In this exemplary embodiment, if the receptionist references a manual or other data during an interaction, the information concerning this reference action is stored in association with the utterance content as of this time, and this data is presented to the receptionist later when a similar utterance content occurs. It is therefore possible to assist a receptionist without needing to previously prepare assistance information.

This exemplary embodiment also presents the data which were referenced by receptionists in the past. It is therefore possible to present the pieces of assistance information which are needed by a receptionist only.

Moreover, this exemplary embodiment presents a piece of data if, and at the time when, the newest utterance content in the current utterance content column matches an utterance content which is in a similar past utterance content column and which was referenced by a receptionist at least once in the past. It is therefore possible to present the piece of assistance information at the timing when it is needed by the receptionist.

### Fourth Exemplary Embodiment

An interaction assistance apparatus 10D, which is a fourth exemplary embodiment of the present invention, will now be described in detail by referring to the drawings.

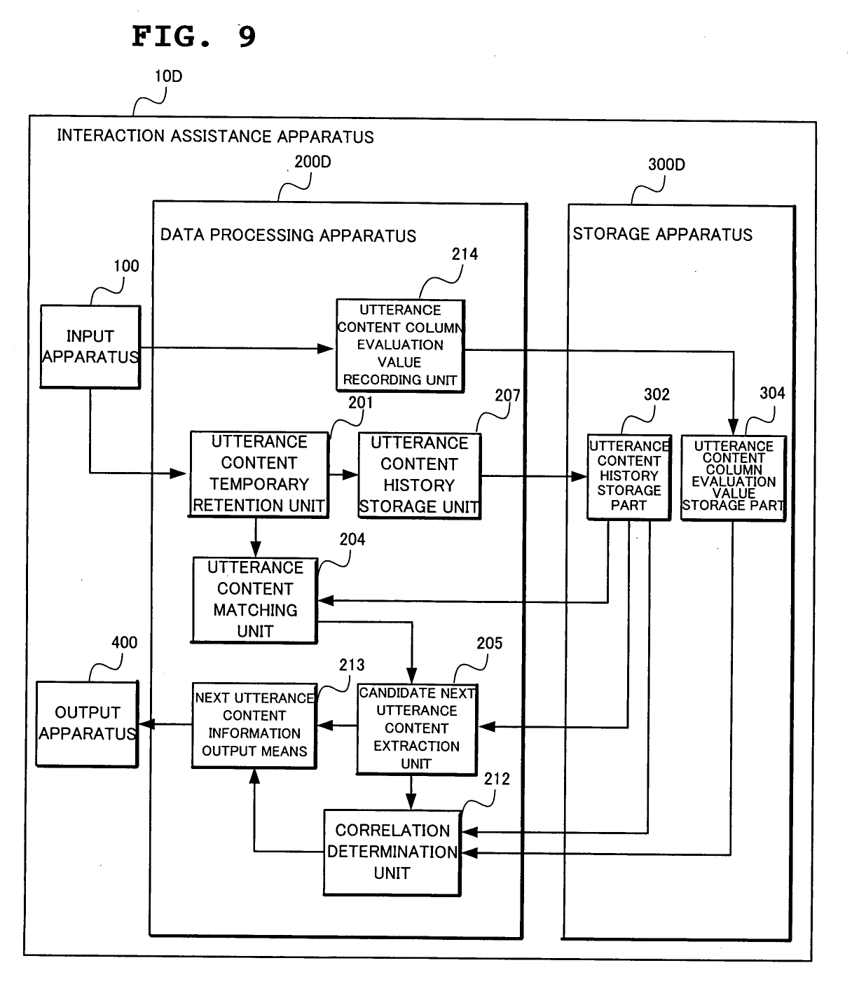

FIG. 9 is a block diagram showing a configuration of the interaction assistance apparatus 10D.

With reference to FIG. 9, the interaction assistance apparatus 10D differs from the interaction assistance apparatuses 10B of the second exemplary embodiment in that the data processing apparatus 200D replaces the candidate next utterance content output unit 206 in the configuration of the data processing apparatus 200B of the second exemplary embodiment shown in FIG. 5 with a correlation determination unit 212, a next utterance content information output unit 213, and an utterance content column evaluation value recording unit 214, and in that the storage apparatus 300D has an utterance content column evaluation value storing part 304 in addition to the configuration of the storage apparatus 300B of the second exemplary embodiment shown in FIG. 5.

The utterance content column evaluation value storage part 304 stores evaluation values, which are values assigned to the results of evaluating the interaction contents (utterance content columns) of the past interactions between receptionists and customers which are stored in the utterance content history storage part 302. More specifically, each evaluation value (utterance content column evaluation value) indicates whether a particular utterance content column is formed with utterance contents which led to a good result or with those which led to a bad result.

When a receptionist is engaged in an interaction with a particular purpose in mind, data which indicates whether or not the previous receptionist could achieve the purpose by the interaction content (utterance content column) of this interaction, may be used as an utterance content column evaluation value. This can be realized by regarding an utterance content column to be a good utterance content column if the previous receptionist could achieve the purpose through this column and to be a bad utterance content column if not and storing the utterance content column in association with either a success or failure data.

For example, a front window receptionist who is responsible for accepting cancellations of services may interact with a customer for the purpose of persuading the customer to withdraw his/her request for cancellation of a service. In this case, a value which indicates whether or not the customer withdrew his/her request for cancellation as a result of an interaction content (utterance content column) may be used as an utterance content column evaluation value; an utterance content column which led to the withdrawal of the customer's cancellation request is then regarded to be a good one and an utterance content column which did not is regarded to be a bad one.

In other cases where a receptionist interacts with a customer for the purpose of decreasing a certain value which is determined based on an utterance content column, then the value itself may be used as an utterance content column evaluation value. In these cases, an utterance content column with a smaller value is regarded to be better and an utterance content column with a larger value to be worse.

For example, a window receptionist engaged in product support may interact with a customer, targeting to provide an answer to an inquiry of the customer in a shorter time. In this case, the time required for the receptionist to provide an answer to the customer may be defined as an utterance content column evaluation value; an utterance content column is regarded to be a good utterance content column if it took a shorter time before providing an answer and a bad utterance content column if it took a longer time.

In cases where a receptionist interacts with a customer for the purpose of increasing a certain value which is determined based on an utterance content column, the value itself may also be used as an utterance content column evaluation value. In these cases, an utterance content column with a larger value is regarded to be better and an utterance content column with a smaller value to be worse.

For example, a window receptionist engaged in the sale of products may interact with a customer, targeting to increase a total price of products purchased by a customer. In this case, the total price of products purchased by the customer as a result of the interaction content (utterance content column) of an interaction may be defined as an utterance content column evaluation value; an utterance content column is regarded to be a good utterance content column if the total price of products purchased by the customer is higher and a bad utterance content column if the total price is lower.

The correlation determination unit 212 determines whether or not each of the candidate next utterance contents extracted by the candidate next utterance content extraction unit 205 is highly correlated with the utterance content column evaluation value of each of the utterance content columns containing the candidate next utterance contents stored in the utterance content column evaluation value storage part 304.

More specifically, if the utterance content column evaluation value is almost the same among the utterance content columns individually having utterance contents which are of the same type and which can be used as candidate next utterance contents, then the correlation is determined to be high. If the utterance content column evaluation value varies among these columns, the correlation is determined to be low. If there is a high correlation between a candidate next utterance content and an utterance content column evaluation value, a typical utterance content column evaluation value of the utterance content column continuing that candidate next utterance content is also obtained.

If there is a candidate next utterance content having a high correlation with an utterance content column evaluation value, the next utterance content information output unit 213 combines into a set the candidate next utterance content and the information concerning the result of the typical interaction content (utterance content column) when the candidate next utterance content was selected for the past utterance content column, that is, whether it was a good or bad utterance content column, and outputs the set through the output apparatus 400.

Since an utterance content column evaluation value is an evaluation value which indicates whether an utterance content column was good or bad, it is possible to present a receptionist with the result of the typical interaction content (utterance content column) when each of the candidate next utterance contents was selected for the past utterance content column based on the utterance content column evaluation value of the typical utterance content column.

As the result of an interaction content (utterance content column), a “good” or “bad” evaluation may be presented, or otherwise a value which indicates how good or how bad the interaction content was may be presented.

On completion of the interaction, the utterance content column evaluation value recording unit 214 acquires the utterance content column evaluation value assigned to the interaction content (utterance content column), and the utterance content history recording unit 207 records in the utterance content column evaluation value storage part 304 the acquired utterance content column evaluation value in association with the utterance content histories recorded in the utterance content history storage part 302.

Utterance content column evaluation values may be input by the receptionist through the input apparatus 100 or, if possible, may be acquired automatically by the system.

The operation of the interaction assistance apparatus 10D will now be described in detail referring to the drawings.

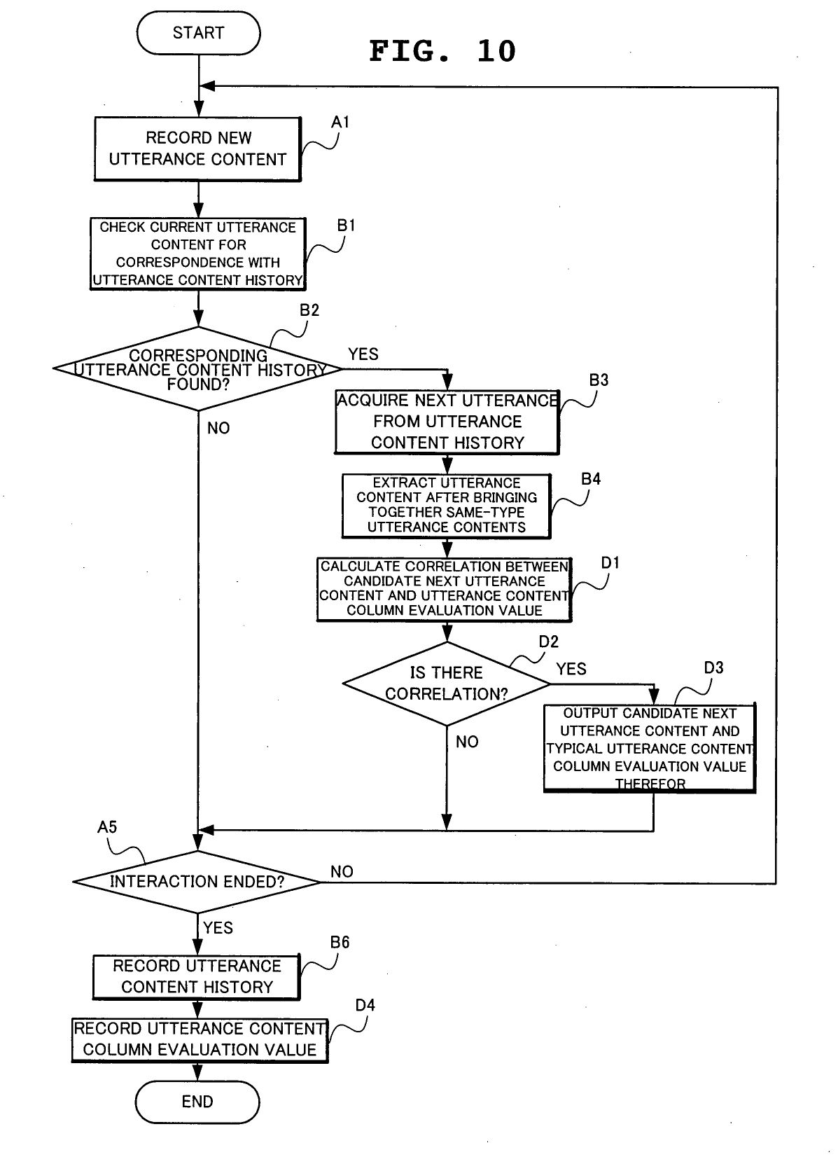

FIG. 10 is a flow chart showing the operation of the interaction assistance apparatus 10D.

The operations of the utterance content temporary retention unit 201, the utterance content matching unit 204, the candidate next utterance content extraction unit 205, and the utterance content history recording unit 207 of this exemplary embodiment, shown as steps A1, B1, B2, B3, B4, A5, and B6 in FIG. 10, are omitted from the description below because they are the same as the operation of the units 201, 204, 205, and 207 of the second exemplary embodiment.

In this exemplary embodiment, for each of the candidate next utterance contents extracted in step B4, the correlation determination unit 212 acquires the utterance content column evaluation value for the utterance content column which contains the candidate next utterance content, and calculates the correlation between the candidate next utterance content and the utterance content column evaluation value. The correlation determination unit 212 also obtains, for the candidate next utterance content having a high correlation with the utterance content column evaluation value, the utterance content column evaluation value for the typical utterance content column when the utterance content was used (step D1).

If there is a candidate next utterance content having a high correlation with an utterance content column evaluation value, the next utterance content information output unit 213 obtains the result of the typical interaction content (utterance content column) when the candidate next utterance content was selected (utterance content column evaluation value), and combines the result thus obtained and the candidate next utterance content into a set and presents the set to the receptionist (steps D2 and D3).

If there is no correlation, the candidate next utterance content only is presented to the receptionist.

On completion of the interaction, the utterance content column evaluation value recording unit 214 acquires the utterance content column evaluation value and records it in the utterance content column evaluation value storage part 304 (step D4).

Similarly to the second exemplary embodiment, the fourth exemplary embodiment may be configured such that the utterance content history storage part 302 brings together and retains past utterance contents which correspond among one another, in advance when recording utterance content histories or non-synchronously with the progress of an interaction through a preliminary process, thereby omitting the bringing together process by the candidate next utterance content extraction unit 205. This exemplary embodiment may also be configured such that, when recording utterance content column evaluation value or in a preliminary process performed non-synchronously with the progress of an interaction, the correlation determination unit 212 calculates the correlation between each of the past utterance contents which have been brought together and the utterance content column evaluation value for each of the utterance content columns which respectively contain these utterance contents, and that the utterance content history storage part 302 previously stores each of the utterance contents having a high correlation with the utterance content column evaluation value in association with the typical utterance content column evaluation value for the utterance content column when the utterance content was adopted, thereby avoiding the process from being performed every time an utterance content is input.

While the first to fourth exemplary embodiments of the present invention can of course be realized in hardware, it is also possible to realize these exemplary embodiments in software by running the response assistance program 50 which executes the various functions on the data processing apparatus of a computer processing apparatus. This interaction assistance program 50 realizes the above-described functions by being stored in a magnetic disc, semiconductor memory, or other storing medium, loaded onto and controlled by the CPU 200A-1, etc., on the data processing apparatuses 200A to 200D.

The effects of the fourth exemplary embodiment will be described below.

In this exemplary embodiment, if in past utterance content columns important utterance contents exist as candidates of the next utterance content to be spoken immediately following the newest utterance content, i.e., utterance contents which were a decisive factor for the interaction contents (utterance content columns) to be ultimately good or bad, these utterance contents are presented to a receptionist together with the results of the typical past utterance content columns containing these utterance contents. By this, it becomes possible for the receptionist to select an utterance content which typically leads to a good result and avoid utterance contents which typically lead to bad results.

### Fifth Exemplary Embodiment

An interaction assistance apparatus 10E, which is a fifth exemplary embodiment of the present invention, will now be described in detail by referring to the drawings.

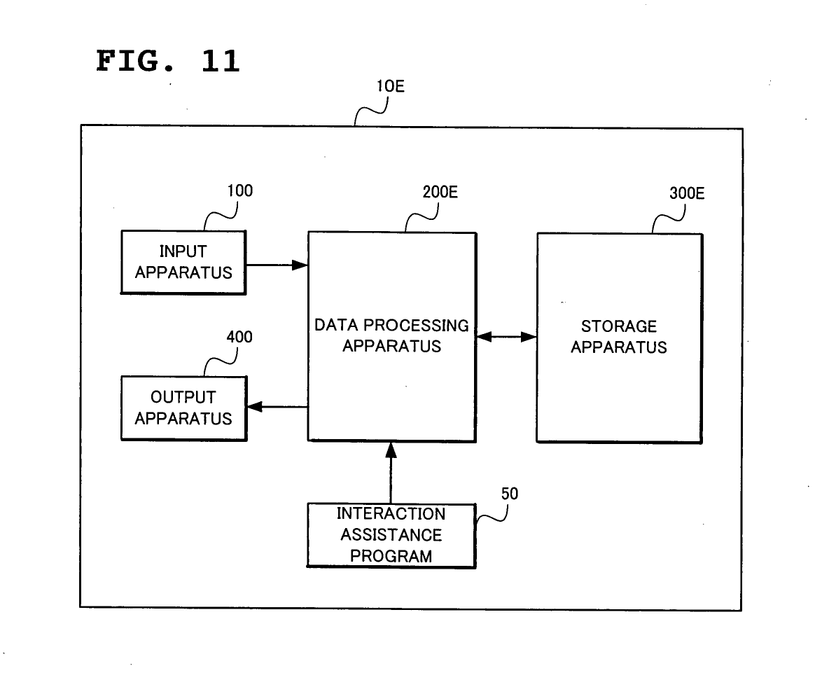

FIG. 11 is a block diagram showing a configuration of the interaction assistance apparatus 10E.

With reference to FIG. 11, similarly to the first to fourth exemplary embodiments of the present invention, the interaction assistance apparatus 10E is configured to comprise an input apparatus 100, a data processing apparatus 200E, a storage apparatus 300E, and an output apparatus 400.

The response assistance program 50 is loaded onto the data processing apparatus 200E to control the operation of the data processing apparatus 200E. The storage apparatus 300E is similarly configured to the storage apparatuses 300A to 300D4 of the first to fourth exemplary embodiments.

The data processing apparatus 200E is controlled by the response assistance program 50 to perform the same process as the data processing apparatuses 200A to 200D of the first to fourth exemplary embodiments.

If a receptionist interacts with a customer via telephone, the first to fifth exemplary embodiments of the present invention may be configured to separately provide an input apparatus through which to input the receptionist's utterance contents, such as a microphone, and an input apparatus through which to input the customer's utterance contents, such as a telephone line interface. If there is more than one receptionist, these exemplary embodiments may be configured to provide a plurality of input apparatuses for receptionists and those for customers.

Furthermore, while in the descriptions of the first to fifth exemplary embodiments of the present invention configurations have been illustrated wherein the input apparatus 100 and the output apparatus 400 are directly connected to the data processing apparatuses 200A to 200E, each of these exemplary embodiments may have a configuration wherein the receptionist assistance apparatus which comprises the input apparatus 100 and the output apparatus 400 is installed in a remote location and is connected to the data processing apparatus via a network line.

### First Example

The first example of the present invention will now be described with reference to the drawings. This example corresponds to the first exemplary embodiment of the present invention.

In this example, one or more pairs of an utterance content which represents the content of an utterance spoken by a receptionist, and an utterance content which represents the content of an immediately following utterance spoken by a customer are written and stored in the assistance information storage part 301 as conditions for assistance information to be presented. Assistance information is presented when all the components of an utterance content pair written as the presentation conditions have occurred during a period from the start of an interaction between a receptionist and a customer up to the utterance content corresponding to the newest utterance.

In the assistance information storage part 301, the pieces of assistance information as shown in FIG. 12 are previously stored.

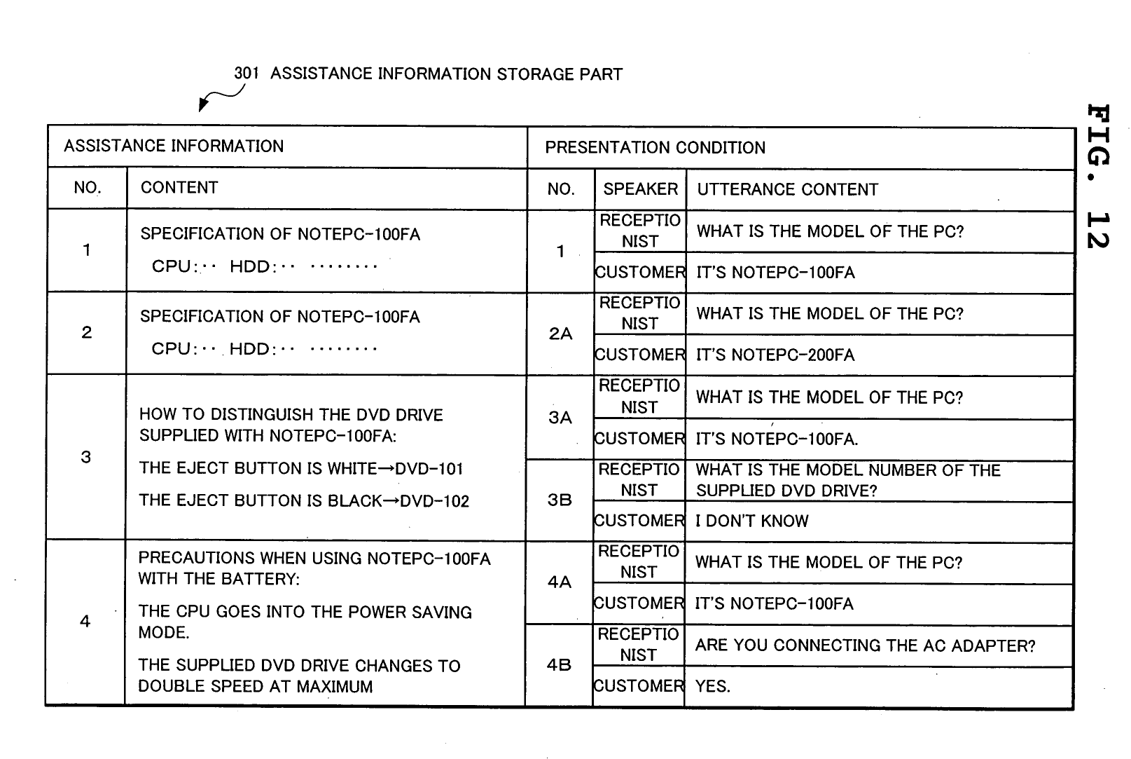

In the description below, a case is taken as an example in which the interaction content of an interaction between a receptionist and a customer comprises the utterance contents as shown in FIG. 13.

This example assumes that two utterance contents are identical to each other if a matching ratio for the independent words contained in these utterance contents is 70% or higher. For example, suppose there are two utterance contents: “What is the model of your PC?” and “What is the model of the PC?” The first content contains four words: what, model, your, and PC. The second contains three words: what, model, and PC. These two utterance content are assumed to be identical because 75% of the words in the first content match those in the second and because 100% of the words in the second content match those in the first.

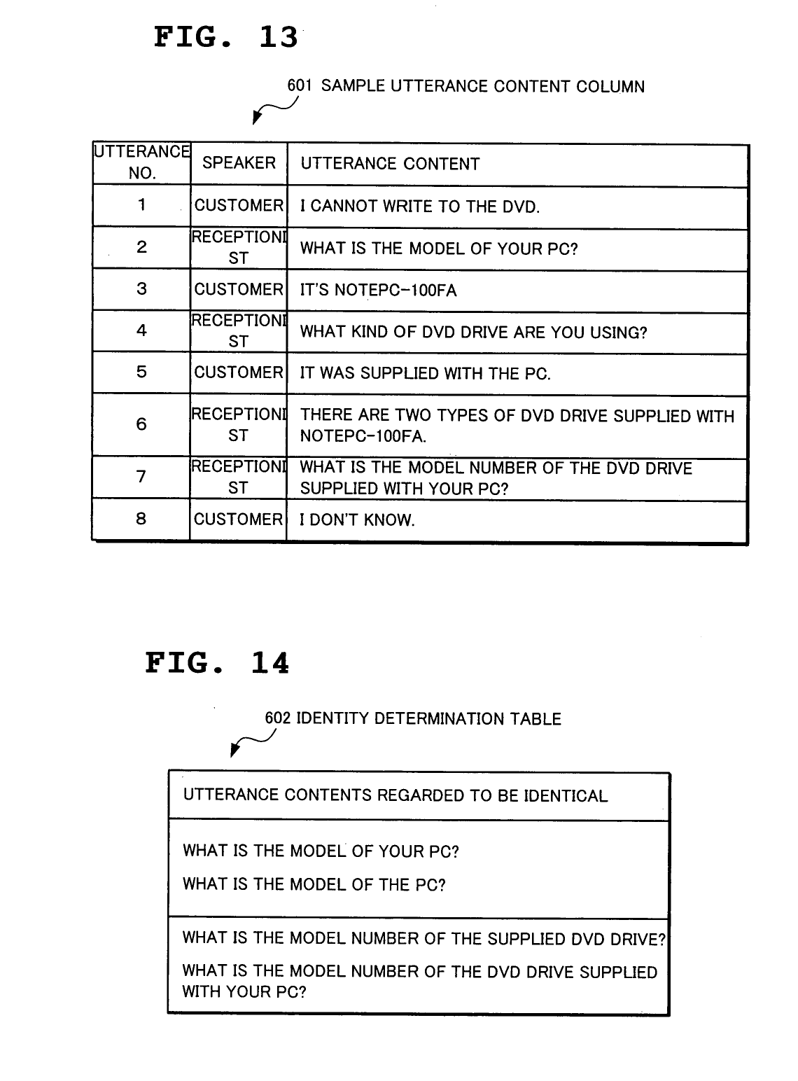

Thus, in the process of determining the identity between two different utterance contents, the utterance contents in the same box in the table of FIG. 14, for example, are assumed to be identical to each other although they do not match exactly each other.

First, when the customer speaks the utterance No. 1, the utterance content temporary retention unit 201 temporarily retains the utterance content which represents the content of the utterance No. 1.

The utterance content condition matching unit 202 then checks the utterance contents temporarily retained in the utterance content temporary retention unit 201 against each of the assistance information presentation conditions which are stored in the assistance information storage part 301, and extracts the piece of assistance information whose presentation conditions have been satisfied, only when all of these conditions have been satisfied for the first time.

At this stage, nothing is output by the assistance information output unit 203 because none of the assistance information presentation conditions are satisfied.

Following this, when the receptionist speaks the utterance No. 2, the utterance content temporary retention unit 201 retains the utterance content of the utterance No. 2, in addition to the utterance content of the utterance No. 1 already retained therein.

The utterance content condition matching unit 202 then checks the utterance contents of the Nos. 1 and 2 utterances which are temporarily retained in the utterance contents temporary retention unit 201 against each of the assistance information presentation conditions which are stored in the assistance information storage part 301. Again, nothing is output by the assistance information output unit 203 because there exists no assistance information whose presentation conditions are satisfied.

Following this, when the customer speaks the utterance No. 3, the utterance content temporary retention unit 201 retains the utterance content of the utterance No. 3, in addition to the utterance contents of the Nos. 1 and 2 utterances already retained therein.

The utterance content condition matching unit 202 then checks the utterance contents of the Nos. 1 to 3 utterances which are retained in the utterance content temporary retention unit 201 against each of the assistance information presentation conditions which are retained in the assistance information storage part 301. As a result of this checking, it is found that the utterance content pair consisting of the utterance contents of the No. 2 and No. 3 utterances satisfy the presentation conditions 1, 3A, and 4A. It is also found that there are no presentation conditions other than these that are satisfied. Therefore, the assistance information 1 only satisfies all the presentation conditions at this stage.

Since assistance information 1 is the assistance information whose presentation conditions have been satisfied by the utterance No. 3 for the first time, the utterance content condition matching unit 202 selects the assistance information 1 as the assistance information to be output and the assistance information output unit 203 outputs the assistance information 1 according to this selection.

Next, when the receptionist speaks the utterance No. 4, the utterance content temporary retention unit 201 retains the utterance content of the No. 4 utterance in addition to the utterance contents of the Nos. 1 to 3 utterances, and the utterance content condition matching unit 202 determines whether or not each of the assistance information presentation condition is satisfied. Similarly to when the utterance No. 3 was spoken, although the assistance information 1 only satisfies the presentation condition, the utterance content condition matching unit 202 does not select the assistance information 1 at this time as the assistance information for output, because all the presentation conditions for assistance information 1 have not yet been satisfied as of the occurrence of utterance No. 4, which is the current utterance content. Therefore, nothing is output by the assistance information output unit 203.

When the Nos. 5 to 7 utterances are spoken, the results of the processing are the same as above and therefore nothing is output by the assistance information output unit 203.

Following this, when the receptionist speaks the utterance No. 8, the utterance content temporary retention unit 201 retains the utterance content of this utterance in addition to the utterance contents of the Nos. 1 to 7 utterances, and the utterance content condition matching unit 202 determines whether or not each of the assistance information presentation condition is satisfied. At this stage, similarly to the above, the presentation condition 3B is satisfied by the No. 7 and No. 8 utterance content pair, in addition to the presentation conditions 1, 3A, and 4A, which have already been satisfied by the No. 2 and No. 3 utterance content pair. As a result, all the presentation conditions for the assistance information 3 have been satisfied for the first time. Since the assistance information 3 satisfies all the presentation conditions for the first time at this point, the utterance content condition matching unit 202, therefore, selects the assistance information 3 as the assistance information for output and the assistance information output unit 203 outputs the assistance information 3 according to this selection.

In this example, the assistance information 1 concerning the specification for NOTEPC-100FA is presented to the receptionist based on the utterance contents Nos. 2 and 3, at the time when it is confirmed that the customer's PC is NOTEPC-100FA.

In this example, at the time when it is found through the utterance content No. 7 and the utterance content No. 8 that the customer does not know the model number of the DVD drive incorporated in the PC, the assistance information 3 concerning how to distinguish the DVD drive supplied with NOTEPC-100FA is presented to the receptionist.

Although the assistance information 4 relates to NOTEPC-100FA and the DVD drive supplied therewith, this is not presented to the receptionist as of the time of the utterance contents Nos. 1 to 8 in the current interact content between the receptionist and the customer because the presentation conditions for the assistance information 4 are not satisfied.

### Second Example

The second example will now be described with reference to the drawings. This example corresponds to the second exemplary embodiment of the present invention.

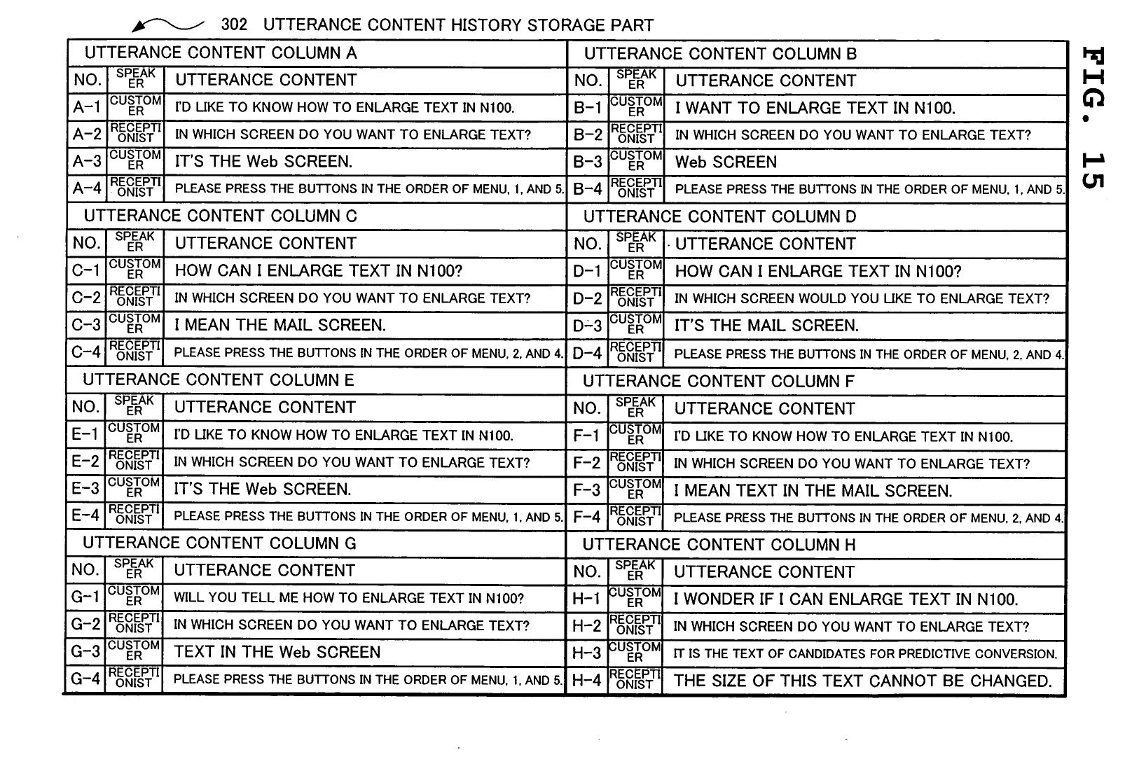

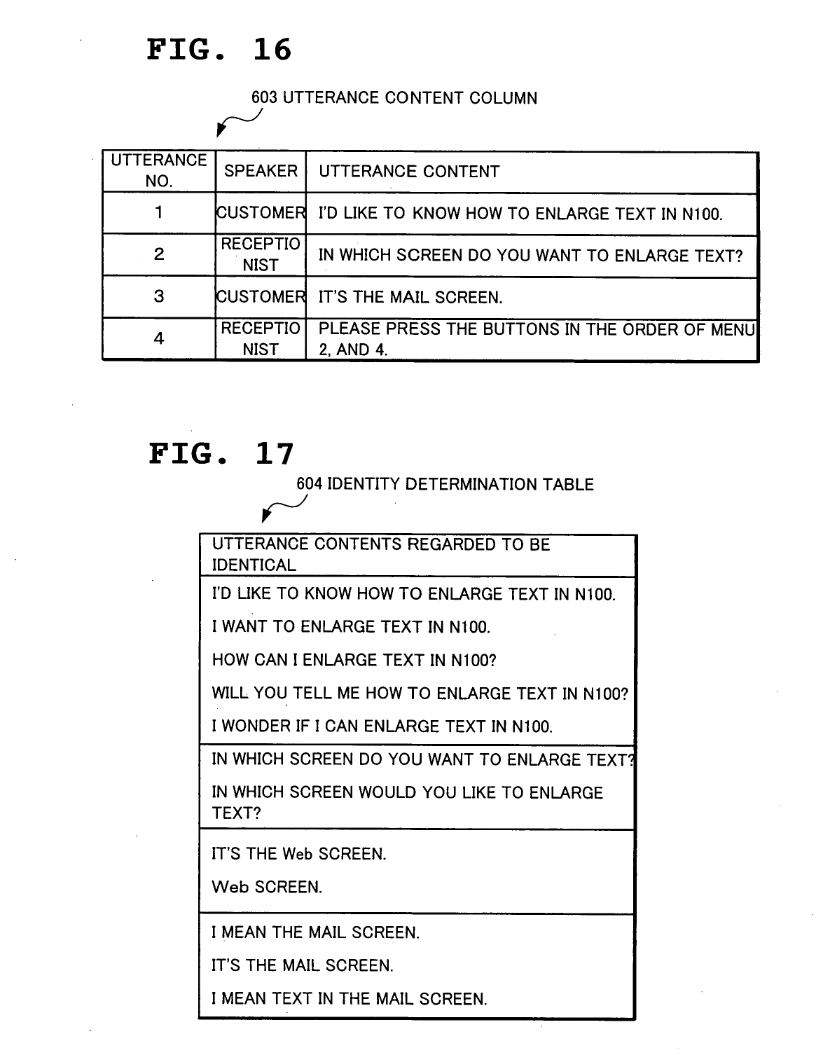

The description below of this example assumes that the history storage part 302 previously stores the histories of the utterance contents which form the past interaction content as shown in FIG. 15. The interaction content of an interaction between a receptionist and a customer comprises the utterance contents as shown in FIG. 16.

Similarly to the first example, this example assumes that two utterance contents are identical to each other if a matching ratio for the independent words contained in these utterance contents is 70% or higher. The utterance contents in the same box in the table of FIG. 17, for example, are assumed to be identical to each other although they do not exactly match.

In this example, if a utterance content sequence within the current interaction between a receptionist and a customer from the one at the start to the newest one consecutively occur in the same order as a content sequence within the interaction content of a past interaction, then the current utterance content sequence and the past utterance content sequence are regarded to correspond to each other. In addition, in the process of bringing together utterance contents of the same type into one for presentation to the receptionist as a candidate next utterance content, an utterance content resulting from bringing together next utterance contents with an occurrence frequency of 30% or higher is selected as the representative candidate next utterance content in relation to the utterance content of the past utterance corresponding to the utterance content of the newest utterance.

First, when the customer speaks the utterance No. 1, the utterance content temporary retention unit 201 temporarily retains the utterance content of this utterance No. 1.

The utterance content matching unit 204 then checks the utterance content of the utterance No. 1 temporarily retained in the utterance content temporary retention unit 201 for correspondence with each of the utterance content columns retained in the utterance content history storage part 302. All of the utterance content columns A to H in FIG. 15 are regarded to correspond to the current No. 1 utterance content, because the first utterance content of these utterance content (A-1, B-1, C-1, D-1, E-1, F-1, G-1, and H-1) is identical to the No. 1 utterance content.

For each of the utterance contents A-1, B-1, C-1, D-1, E-1, F-1, G-1, and H-1, which correspond to the utterance content of the newest utterance No. 1, the candidate next utterance content extraction unit 205 acquires the immediately following utterance contents, i.e., A-2, B-2, C-2, D-2, E-2, F-2, G-2, and H-2, and brings together the utterance contents of the same type into one.

The utterance contents A-2, B-2, C-2, D-2, E-2, F-2, G-2, and H-2 can be regarded to be of the same type, so they are brought together into one utterance content. Suppose, after this bringing together process, A-2 (the first element of this utterance content) is chosen to represent this utterance content. Then the utterance content resulting from the bringing together process is “In which screen do you want to enlarge text?” This means that all the candidate next utterance contents corresponding to the utterance content of the utterance No. 1 which represents the newest utterance content have been brought together into this utterance content.

In this way, the candidate next utterance content extraction unit 205 extracts the utterance content “In which screen do you want to enlarge text?” as the candidate next utterance content, and the candidate next utterance content output unit 206 presents the utterance content to the receptionist as the candidate utterance content that should be spoken following the utterance No. 1.

Following this, when the receptionist speaks the utterance No. 2, the utterance content temporary retention unit 201 retains the utterance content of the utterance No. 2, in addition to the utterance content of the utterance No. 1 already retained therein.

The utterance content matching unit 204 then checks the utterance content of the newest utterance No. 2 temporarily retained in the utterance content temporary retention unit 201 for correspondence with each of the past utterance content columns stored in the utterance content history storage part 302. In this case, for all of the utterance content columns A to H shown in FIG. 15, their first and second utterance contents are respectively of the same type as the utterance contents of the utterances Nos. 1 and 2, and therefore all of these utterance content columns can be regarded to correspond to the interaction content of the current interaction between the receptionist and the customer.

At this stage, for each of the utterance contents A-2, B-2, C-2, D-2, E-2, F-2, G-2, and H-2, which correspond to the utterance content of the newest utterance No. 2, the candidate next utterance content extraction unit 205 acquires the immediately following utterance contents, i.e., A-3, B-3, C-3, D-3, E-3, F-3, G-3, and H-3, and brings together the utterance contents of the same type into one.

Of these eight utterance contents, the utterance contents A-3, B-3, E-3, and G-3 are of the same type as one another, so are the utterance contents C-3, D-3, and F-3. However, H-3 is not of the same type as any of the other utterance contents. This means that three utterance contents result from the bringing together process. These are “It's the Web screen” (representative, the utterance A-3), which has resulted from bringing together the utterance contents A-3, B-3, E-3, and G-3; “I mean the mail screen” (representative, the utterance C-3), resulting from the utterance contents C-3, D-3, and F-3; and “It is the text of candidates for predictive conversion,” which is H-3.

The utterance content “It's the Web screen” is the result of bringing together the four utterance contents (50%) and the utterance content “I mean the mail screen” is the result of bringing together the three utterance contents (37.5%) among the total eight. Since both the utterance contents show an occurrence frequency of over 30%, both are extracted as the representative candidate next utterance contents. On the other hand, the utterance content “It is the text of candidates for predictive conversion” has resulted from only one utterance content (12.5%) among the total eight after the bringing together process, and thus this is not extracted as the representative candidate next utterance content.

During the process of extracting a representative candidate next utterance, it is possible to change as necessary the threshold value for the ratio of same-type utterance contents to the total number of utterance contents.

The candidate next utterance content extraction unit 205 extracts the two utterance content, “It's the Web screen” and “I mean the mail screen,” as the utterance contents which are predicted to be spoken by the customer in reply, and the candidate next utterance content output unit 206 presents these utterance contents to the receptionist as the candidate next utterance contents.

Following this, when the customer speaks the utterance No. 3, the utterance content temporary retention unit 201 retains the utterance content of the utterance No. 3, in addition to the utterance contents of the Nos. 1 and 2 utterances already retained therein.

The utterance content matching unit 204 then checks each of the utterance contents of the current utterance Nos. 1 to 3 temporarily retained in the utterance content temporary retention unit 201 for correspondence with each of the past utterance content columns retained in the utterance content history storage part 302. The past utterance content columns C, D and, F stored in the utterance content history storage part 302 (FIG. 15) are of the same type, with respect to the first to third utterance contents, as the utterance contents of the utterance Nos. 1 to 3 which form the interaction content (utterance content column) of the current interaction (FIG. 16) and therefore these three utterance content columns C, D and, F are regarded to correspond to the utterance content of the current utterance Nos. 1 to 3.

For each of the utterance contents C-3, D-3, and F-3 of the utterances C, D, and F which correspond to the newest utterance No. 3, the candidate next utterance content extraction unit 205 acquires the immediately following utterance contents, i.e., C-4, D-4, and F-4, and brings together the utterance contents of the same type.

These utterance contents C-4, D-4, and F-4 are all the same and brought together into one utterance content “Please press the buttons in the order of Menu, 2, and 4.” The candidate next utterance content extraction unit 205 extracts this utterance content obtained through the bringing together process as the representative candidate next utterance content, and the candidate next utterance content output unit 206 presents the extracted utterance content to the receptionist as the candidate next utterance content.

Following this, when the receptionist speaks the utterance No. 4, the utterance content temporary retention unit 201 retains the utterance content of the utterance No. 4, in addition to the utterance contents of the utterance Nos. 1 to 3 previously retained therein.

The utterance content of the newest utterance No. 4 retained in the utterance content temporary retention unit 201 is determined by the utterance content matching unit 204 to correspond to the past utterance content C-4, D-4, and F-4. However, there are no next utterance contents because these past utterance contents are respectively the last utterance contents which correspond to the current utterance No. 4. Therefore, nothing is extracted by the candidate next utterance content extraction unit 205 and nothing is presented by the candidate next utterance content output unit 206 to the receptionist.

When the current interaction between the receptionist and the customer ends with the utterance content of the utterance No. 4, the utterance content history recording unit 207 adds for recording the current utterance contents of the utterance Nos. 1 to 4, which have been retained by the utterance content temporary retention unit 201, to the utterance content history storage part 302.

As described above, if there is an equivalent past utterance content stored, this example presents it to a receptionist as a candidate next utterance content at an appropriate timing according to the progress of the current utterance content. In addition, on completion of the current interaction between the receptionist and the customer, this example additionally records the utterance contents spoken during that interaction in the utterance content history storage part 302 so that these utterance contents can be presented to receptionists during future interactions.

While this example has been described using an example in which the candidate next utterance content extraction unit 205 acquires utterance contents which can be spoken immediately after the current utterance content from among the past utterance content columns (interaction contents) and brings together those which can be regarded to be of the same type, it is also possible to omit the bringing together performed by the candidate next utterance content extraction unit 205 by using the utterance content history storage part 302 to previously bring together and retain past utterance contents which correspond to one another.

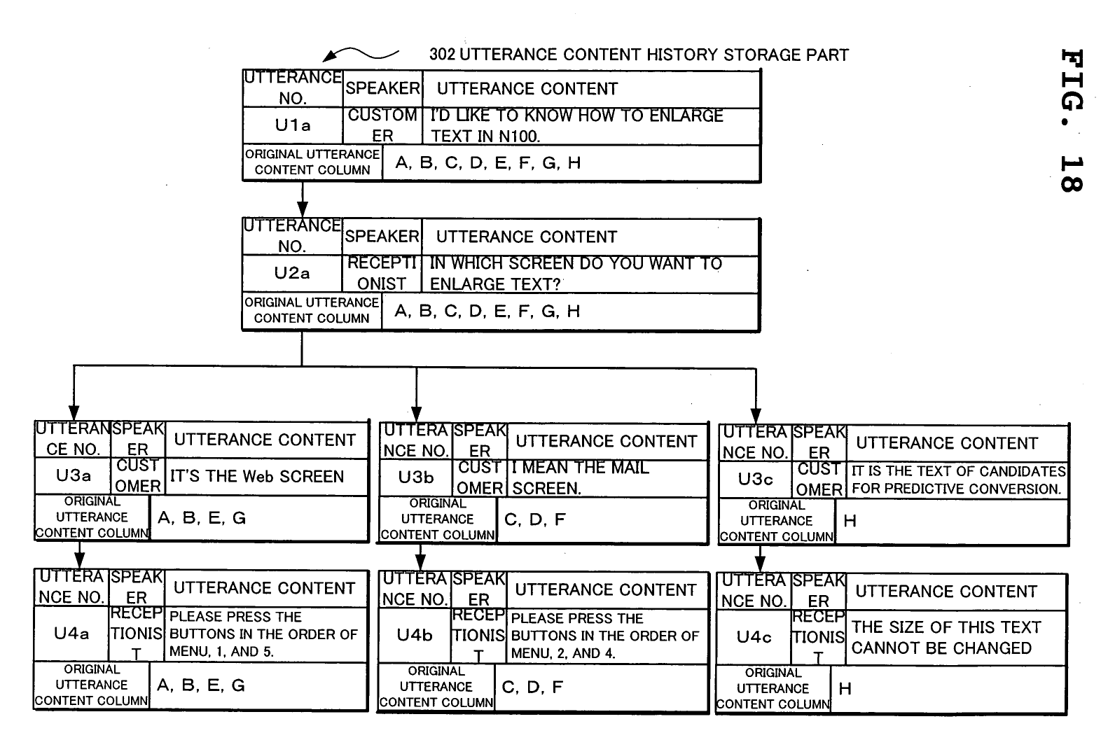

FIG. 18 shows an utterance content history storage part 302 configured to retain past utterance contents after bringing them together in advance. In this case, the utterance content matching unit 204 checks the current utterance content columns retained in the utterance content temporary retention unit 201 for correspondence with U1a→U2a→U3a→U4a, U1a→U2a→U3b→U4b and U1a→U2a→U3c→U4c, which are the utterance content columns resulting from the bringing together process.

As an example, the operation when the receptionist has just spoken the utterance No. 2 will be described below. The utterance contents of the utterance Nos. 1 and 2 are currently retained in the utterance content temporary retention unit 201. Since these utterance contents are respectively identical to the utterance contents U1a and U2a in FIG. 18, three utterance content columns, U1a→U2a→U3a→U4a, U1a→U2a→U3b→U4b, and U1a→U2a→U3c→U4c, correspond to the utterance contents of the current utterance Nos. 1 and 2.

The candidate next utterance content extraction unit 205 then acquires the utterance contents U3a, U3b and, U3c from the past utterance content column. These utterance contents are located next to U2a, which is the utterance content corresponding to the utterance content of the current utterance No. 2. U2a is the result of bringing together eight utterance contents. On the other hand, U3a, U3b, and U3c are respectively the results of bringing together four, three, and 1 utterance contents, each representing 50%, 37.5%, and 12.5% of the total. Based on these results, the candidate next utterance content extraction unit 205 extracts only U3a and U3b as representative candidate next utterance contents, because these utterance contents have an occurrence frequency of over 30%, respectively.

### Third Example

The third example will now be described with reference to the drawings. This example corresponds to the third exemplary embodiment of the present invention.

Similarly to the second example, it is assumed in this example that the past utterance content columns in FIG. 15 are already stored in the utterance content history storage part 302. The interaction content between a receptionist and a customer comprises the utterance contents as shown in FIG. 16.

Conditions for two utterance contents to be regarded to be of the same type and conditions for the current utterance content and a past utterance content to correspond to each other are also the same as those used in the second example.

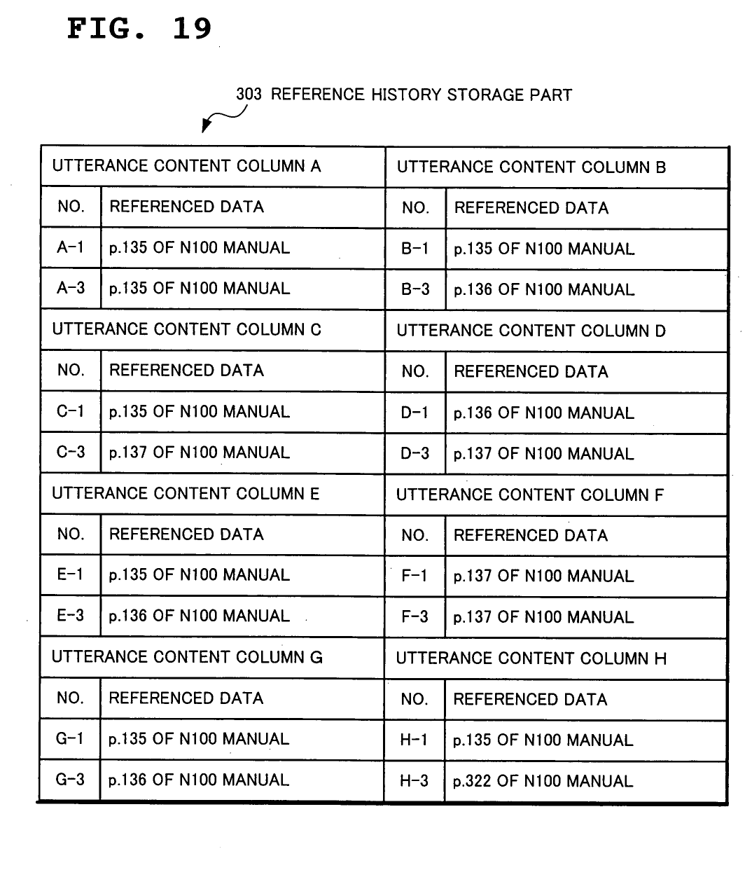

The reference history storage part 303 of this example is shown in FIG. 19.

FIG. 19 indicates that, during the past utterance content column shown in FIG. 15, the receptionist referenced the corresponding reference data at the times of the utterance contents which are assigned the numbers within the utterance content columns A to H in FIG. 19.

In this example, the utterance content temporary retention unit 201 first retains the utterance content of the utterance No. 1 when the customer speaks this utterance No. 1.

The utterance content matching unit 204 then checks each of the utterance contents of the current utterance No. 1 temporarily retained in the utterance content temporary retention unit 201 for correspondence with each of the past utterance content columns retained in the utterance content history storage part 302. As mentioned in the description of the second example, at this stage, all of the utterance content columns A to H in FIG. 15 correspond to the utterance content of the current utterance No. 1.

During each of the utterance content columns A to H, the reference data extraction unit 208 acquires from the reference history storage part 303 the information concerning the data referenced by the receptionist in the past as of the times of the utterance contents A-1, B-1, C-1, D-1, E-1, F-1, G-1, and H-1, which correspond to the utterance content of the current utterance No. 1.

Referring to FIG. 19, the data reference by the receptionist and the number of times of references to such data as of the time of the utterance content of this utterance No. 1 is six times for “p. 135 of the N100 manual,” once for “p. 136 of the N100 manual,” and once for “p. 137 of the N100 manual.”

In this example, the reference data extraction unit 208 selects the most frequently referenced data as the representative data.

In this case, the reference data extraction unit 208 selects “p. 135 of the N100 manual” as the representative data referenced by the receptionist as of the time of the past utterance content corresponding to the utterance content of the current utterance No. 1. The reference data output unit 209 then acquires “p. 135 of the N100 manual” and presents it to the receptionist.

The reference data monitoring unit 210 continuously monitors as to whether or not the receptionist references data of some kind and, if the receptionist is detected to have referenced data of some kind as of the time of the utterance content of the current utterance No. 1, stores the information in association with the utterance content of the utterance No. 1.

It is assumed in this example that the receptionist actually references “p. 135 of the N100 manual” in accordance with the information presented. In this case, the reference data monitoring unit 210 stores “p. 135 of the N100 manual” as the information concerning the data referenced for the utterance content of the utterance No. 1.

Following this, when the receptionist speaks the utterance No. 2, the utterance content temporary retention unit 201 retains the utterance content of the utterance No. 2, in addition to the utterance content of the utterance No. 1 already retained therein.

The utterance content matching unit 204 then checks each of the utterance contents of the current utterance Nos. 1 to 2 retained in the utterance content temporary retention unit 201 for correspondence with each of the past utterance content columns retained in the utterance content history storage part 302. As mentioned in the description of the second example, at this stage as well, all of the utterance content columns A to H in FIG. 15 correspond to the utterance content of the current utterance Nos. 1 and 2.

The reference data extraction unit 208 acquires from the reference history storage part 303 the information concerning the data referenced by the receptionist in the past as of the times of the utterance contents A-2, B-2, C-2, D-2, E-2, F-2, G-2, and H-2, which correspond to the utterance content of the newest utterance No. 2.

Referring to FIG. 19, there are no data referenced by the receptionist as of the times of these utterance Nos. 1 and 2, so nothing is extracted by the reference data extraction unit 208 and nothing is output by the reference data output unit 209.

Since no data has been referenced by the receptionist, no information is stored by the reference data monitoring unit 210.

Following this, when the receptionist speaks the utterance No. 3, the utterance content temporary retention unit 201 retains the utterance content of the utterance No. 3, in addition to the utterance contents of the Nos. 1 and 2 utterances already retained therein.

The utterance content matching unit 204 then checks each of the utterance contents of the current utterance Nos. 1 to 3 temporarily retained in the utterance content temporary retention unit 201 for correspondence with each of the past utterance content columns retained in the utterance content history storage part 302. As mentioned in the description of the second example, three utterance content columns C, D, and F correspond to the current utterance content.

The reference data extraction unit 208 acquires from the reference history storage part 303 the information concerning the data referenced by the receptionist in the past as of the times of the utterance contents C-3, D-3, and F-3, which correspond to the utterance content of the newest utterance No. 3.

Referring to FIG. 19, the data referenced by the receptionist as of the times of the utterance contents C-3, D-3, and F-3 is only “p. 137 of the N100 manual.” Therefore, the reference data extraction unit 208 selects “p. 137 of the N100 manual” as the representative data, and the reference data output unit 209 actually acquires “p. 137 of the N100 manual” and presents it to the receptionist.

Suppose, at this time, the receptionist actually references “p. 137 of the N100 manual” in accordance with the information presented. The reference data monitoring unit 210 then stores “p. 137 of the N100 manual” as the information concerning the data referenced for the utterance content of the utterance No. 3.

Following this, when the receptionist speaks the utterance No. 4, the utterance content temporary retention unit 201 retains the utterance content of the utterance No. 4, in addition to the utterance contents of the utterance Nos. 1 to 3 previously retained therein.

The utterance content matching unit 204 determines that the utterance content columns C, D, and F correspond to the utterance contents of the current utterance Nos. 1 to 4, which is retained in the utterance content temporary retention unit 201.

The reference data extraction unit 208 acquires from the reference history storage part 303 the information concerning the data referenced by the receptionist in the past as of the times of the utterance contents C-4, D-4, and F-4, which correspond to the utterance content of the newest utterance No. 4. However, there are no data referenced by the receptionist as of the times of the utterance contents C-4, D-4, and F-4, so nothing is extracted by the reference data extraction unit 208 and nothing is output by the reference data output unit.

Since no data has been referenced by the receptionist, no information is stored by the reference data monitoring unit.

When the current interaction between the receptionist and the customer ends with the utterance content of the utterance No. 4, the utterance content history recording unit 207 adds for recording the current utterance contents of the utterance Nos. 1 to 4, which have been retained by the utterance content temporary retention unit 201, to the utterance content history storage part 302. Also, the reference history recording unit 211 records “p. 135 of the N100 manual” for the utterance content of the utterance No. 1 and “p. 137 of the N100 manual” for the utterance content of the utterance No. 3, in the reference history storage part 303 as the data referenced by the receptionist at these points in time.

As described above, if an interaction content (utterance content column) of the same type as the current interaction content (utterance content column) was spoken in the past, this example presents the data referenced as of the time of the past utterance content which correspond to the current newest utterance content to the receptionist according to the progress of the current interaction content between the receptionist and the customer. In addition, if there is any data actually referenced during any of the utterance contents which comprise the current interaction content (utterance content column), this information is additionally recorded in the reference history storage part 303.

### Fourth Example

The fourth example will now be described with reference to the drawings. This example corresponds to the fourth exemplary embodiment of the present invention.

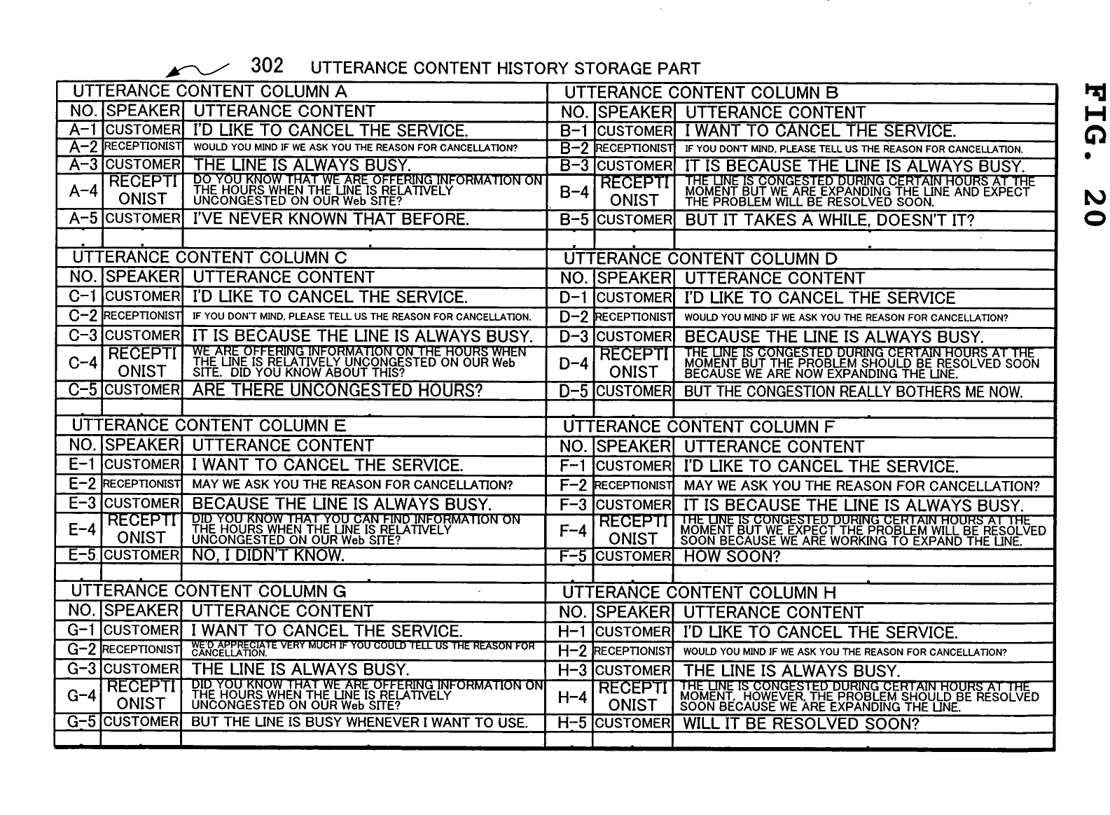

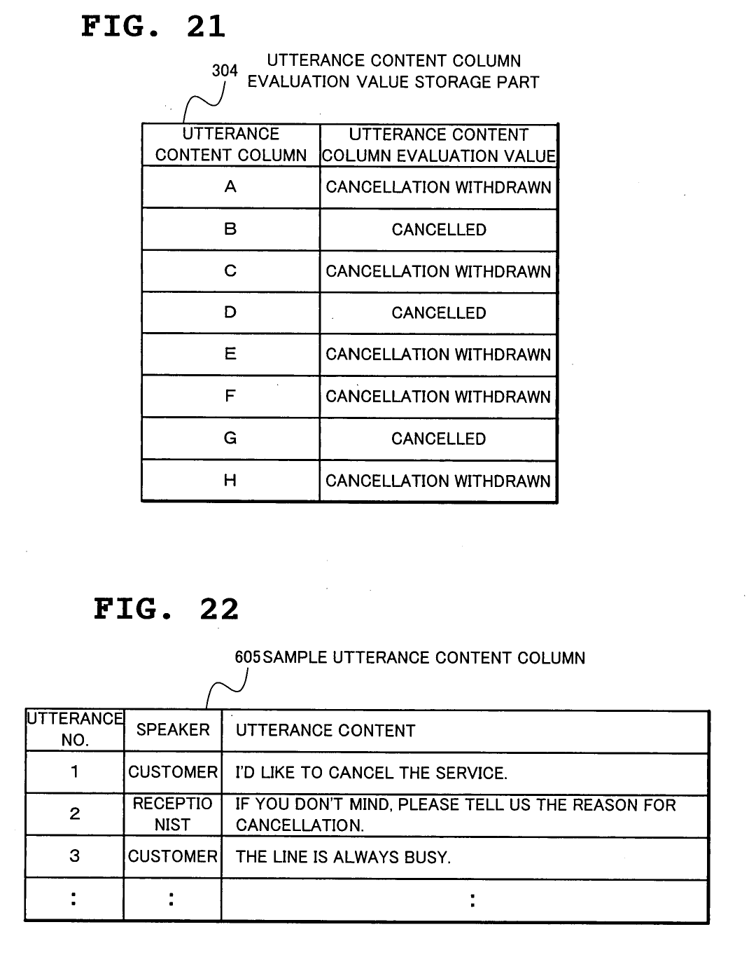

The description below of this example assumes that the utterance content history storage part 302 previously stores the past utterance content columns shown in FIG. 20 (the latter half of the utterance content column is omitted from this figure). The utterance content column evaluation value storage part 304, as shown in FIG. 21, stores utterance content evaluation values, which are values assigned to the results of evaluating the interaction contents (utterance content columns) of the past interactions between receptionists and customers. A receptionist is interacting with a customer with the aim of preventing the customer from canceling a service. To the receptionist, the information as shown in FIG. 21 is presented, which indicates that a past utterance content column with an utterance content column evaluation value of “Cancellation withdrawn” are a good utterance content column and that with an utterance content column evaluation value of “Cancelled” is a bad utterance content column.

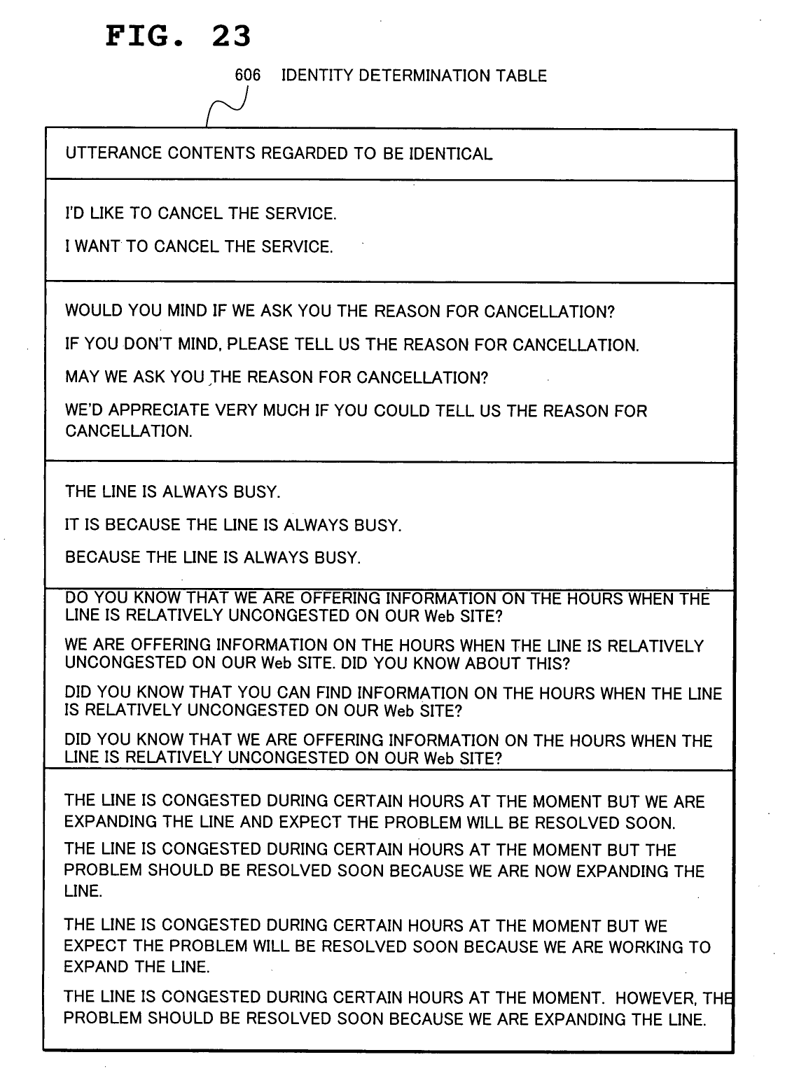

The description below assumes that the receptionist and a customer is engaged in an utterance content column (interaction content) consisting of the utterance contents as shown in FIG. 22 (the latter half of the utterance content column is omitted from this figure, as with the above).

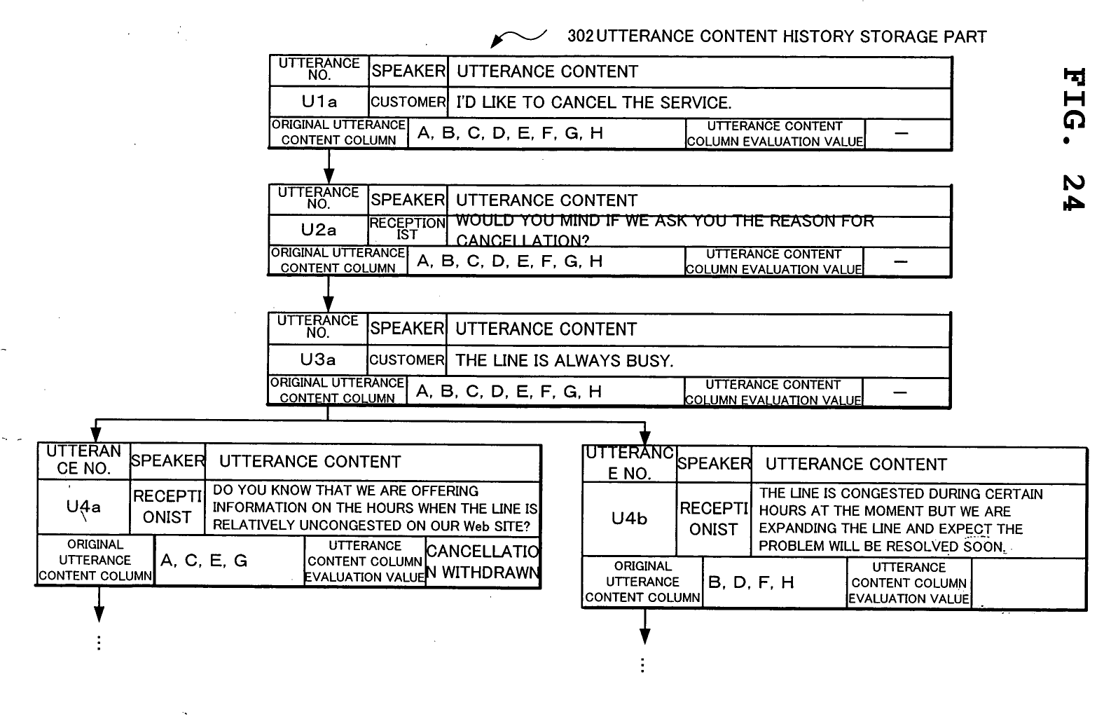

Similarly to the foregoing, this example assumes that two utterance contents are identical to each other if a matching ratio for the independent words contained in these utterance contents is 70% or higher. The utterance contents in the same box in the table of FIG. 23, for example, are assumed to be identical to each other although they do not exactly match.

If an utterance content column in the current interaction between a receptionist and a customer from the utterance content at the start of the interaction to the utterance content of the newest utterance consecutively occur in the same order as a past utterance column, then the current utterance content column and the past utterance content column are regarded to correspond to each other. In addition, in the process of bringing together utterance contents of the same type into one for presentation to the receptionist as a candidate next utterance content, the utterance content of a past utterance corresponding to the current utterance content which results from bringing together utterance contents with an occurrence frequency of 30% or higher is selected as the representative candidate next utterance.

The correlation determination unit 212 of this example checks each of a plurality of utterance content columns which correspond to a candidate next utterance content and determines that there is a high correlation between the candidate next utterance content and the utterance content column evaluation value if 70% or more of the utterance content column evaluation values are the same.

First, when the customer speaks the utterance No. 1, the utterance content temporary retention unit 201 retains the utterance content of this utterance No. 1.

The utterance content matching unit 204 then checks the utterance content of the current utterance No. 1 temporarily retained in the utterance content temporary retention unit 201 for correspondence with each of the utterance content columns retained in the utterance content history storage part 302. All of the utterance content columns A to H in FIG. 20 are regarded to correspond to the current No. 1 utterance content, because the first utterance content of these utterance content columns (A-1, B-1, C-1, D-1, E-1, F-1, G-1, and H-1) is identical to the No. 1 utterance content.

For each of the utterance contents A-1, B-1, C-1, D-1, E-1, F-1, G-1, and H-1, which correspond to the utterance content of the current utterance No. 1, the candidate next utterance content extraction unit 205 acquires the immediately following utterance contents, i.e., A-2, B-2, C-2, D-2, E-2, F-2, G-2, and H-2, and brings together the utterance contents of the same type into one.

These utterance contents can be regarded to be of the same type and thus are brought together into one type of utterance content. Suppose, after this bringing together process, A-2 (the first element of this utterance content) is chosen to represent this utterance content. Then the utterance content resulting from the bringing together process is “Would you mind if we ask you the reason for cancellation? (utterance No. 2)” This means that all the utterance contents corresponding to the utterance content of the current utterance No. 1 have been brought together into this utterance content.

Next, the correlation determination unit 212 determines whether or not there is a high correlation between the candidate next utterance content “Would you mind if we ask you the reason for cancellation?” which has been extracted by the candidate next utterance content extraction unit 205, and the utterance content column evaluation value. This candidate next utterance content has eight different utterance content columns A to H corresponding thereto. Referring to FIG. 21, the utterance content column evaluation values for these utterance content columns A to H consist of five occurrences of “Cancellation withdrawn” and three occurrences of “Canceled.” Since neither of the utterance content column evaluation values account for 70% or higher, the correlation determination unit 212 determines that this candidate next utterance content is not highly correlated with the utterance content column evaluation value. Nothing is output by the next utterance content information output unit 213 at this time.

Following this, when the receptionist speaks the utterance No. 2, the utterance content temporary retention unit 201 retains the utterance content of the utterance No. 2, in addition to the utterance content of the utterance No. 1 already retained therein.

The utterance content matching unit 204 determines that all of the past utterance content columns A to H correspond to the utterance content of the current utterance Nos. 1 and 2. Since all of the utterance contents which correspond to the utterance content of the newest utterance No. 2, i.e., A-2, B-2, C-2, D-2, E-2, F-2, G-2, and H-2, and all of the next utterance contents A-3, B-3, C-3, D-3, E-3, F-3, G-3, and H-3 are of the same type of utterance contents, the candidate next utterance content extraction unit 205 extracts “The line is always busy (utterance A-3)” as the candidate next utterance content after bringing together all of the utterance contents A3 to H3 into one.

Following this, similarly to the process performed on the utterance content of the utterance No. 1, the correlation determination unit 212 determines that the correlation is not high between this candidate next utterance content and the utterance content column evaluation value. Nothing is output by the next utterance content information output unit 213 at this time.

When the customer speaks the utterance No. 3, the utterance content temporary retention unit 201 retains the utterance content of the utterance No. 3, in addition to the utterance contents of the Nos. 1 and 2 utterances already retained therein.

The utterance content matching unit 204 then checks the utterance contents of the current utterance Nos. 1 to 3 temporarily retained in the utterance content temporary retention unit 201 for correspondence with each of the past utterance content columns stored in the utterance content history storage part 302. In this case, for all of the utterance content columns A to H in FIG. 20, their first to third utterance contents are respectively of the same type as the utterance contents of the current utterances Nos. 1 to 3, and therefore all of these utterance content columns A to H can be regarded to correspond to the current utterance Nos. 1 to 3.

For each of the utterance contents A-3, B-3, C-3, D-3, E-3, F-3, G-3, and H-3, which correspond to the utterance content of the newest utterance No. 3, the candidate next utterance content extraction unit 205 acquires the immediately following utterance contents, i.e., A-4, B-4, C-4, D-4, E-4, F-4, G-4, and H-4, and brings together the utterance contents of the same type into one.

Of these eight utterance contents, the utterance contents A-4, B-4, E-4, and G-4 are of the same type as one another, so are the utterance contents B-4, D-4, F-4, and H-4. Therefore, the bringing together process results in two utterance contents: “Do you know that we are offering information on the hours when the line is relatively uncongested on our Web site?” which is the result of bringing together the utterance contents A-4, C-4, E-4, and G-4, and “The line is congested during certain hours at the moment but we are expanding the line and expect the problem will be resolved soon” which is the result of bringing together the utterance contents B-4, D-4, F-4, and H-4. Both are the results of bringing together 50% of the utterance contents and thus are extracted as the candidate next utterance contents.

Next, the correlation determination unit 212 determines whether or not there is a high correlation between each of the candidate next utterance content extracted by the candidate next utterance content extraction unit 205 and the respective utterance content column evaluation value.

The correlation determination unit 212 first determines for “Do you know that we are offering information on the hours when the line is relatively uncongested on our Web site?” which is the candidate next utterance content corresponding to the four utterance content columns A, C, E, and G. Referring to FIG. 21, the utterance content column evaluation values for these utterance content columns A, C, E, and G consist of three occurrences of “Cancellation withdrawn” and one occurrence of “Canceled.” Since the utterance contents whose utterance content column evaluation value is “Cancellation withdrawn” account for over 70%, the correlation determination unit 212 determines that this candidate next utterance content is highly correlated with the utterance content column evaluation value.

Next, the correlation determination unit 212 determines for “The line is congested during certain hours at the moment but we are expanding the line and expect the problem will be resolved soon” which is the candidate next utterance content corresponding to the four utterance content columns B, D, F, and H. Referring to FIG. 21, the utterance content column evaluation values for these utterance content columns consist of two occurrences of “Cancellation withdrawn” and two occurrences of “Canceled.” Since neither of the utterance content column evaluation values account for 70% or higher, the correlation determination unit 212 determines that there is no high correlation between this candidate next utterance content and the utterance content column evaluation value.

The next utterance content information output unit 213 outputs “Do you know that we are offering information on the hours when the line is relatively uncongested on our Web site?” which has been determined to be the candidate next utterance content having a high correlation with the utterance content column evaluation value, along with the information indicating withdrawal of cancellation as the typical result corresponding to this candidate next utterance content.

At this point in time, the receptionist can view the output and select the utterance content “Do you know that we are offering information on the hours when the line is relatively uncongested on our Web site?” which typically resulted in withdrawal of cancellation.

The interaction continues and, when the interaction ends, the receptionist inputs information as to whether the customer cancelled or withdrew cancellation as a result of the interaction content of the interaction with the customer via the input apparatus 100 into the utterance content column evaluation value recording unit 214. The utterance content history recording unit 207 then adds for recording the utterance content column which has been retained in the utterance content temporary retention unit 201 to the utterance content history storage part 302. The utterance content column evaluation value recording unit 214 records the utterance content column evaluation value “Canceled” or “Cancellation withdrawn” as appropriate according to whether the customer cancelled or withdrew cancellation, in association with this utterance content column, in the utterance content column evaluation value storage part 304.

While this example has been described using a case in which the candidate next utterance content extraction unit 205 acquires the candidate next utterance contents for the newest utterance content from among the past utterance content columns and brings together those which can be regarded to be of the same type, it is also possible to omit the bringing together process performed by the candidate next utterance content extraction unit 205 by using the utterance content history storage part 302 to previously bring together and retain past utterance contents of the same type. Moreover, it is further possible to omit part of the process which is performed every time the newest utterance content is input by using a configuration in which the correlation determination unit 212 previously calculates the correlation between each of the past utterance contents resulting from the bringing together process and the utterance content column evaluation value for each of the utterance content columns which respectively contain these utterance contents, and in which the utterance content history storage part 302 stores each of the utterance contents having a high correlation with the utterance content column evaluation value, in association with the typical utterance content column evaluation value for the utterance content column when the utterance content was spoken.

The utterance content history storage part 302 in such configuration is shown in FIG. 24. In this figure, the utterance content history storage part 302 stores the U4a utterance content with a high correlation result and the typical utterance content column evaluation value “Cancellation withdrawn” when this utterance content was adopted, because the correlation between each of the utterance contents resulting from the bringing together process and the utterance content column evaluation value for the utterance content column containing that utterance content.

In this case, the utterance content matching unit 204 checks the current utterance content column retained in the utterance content temporary retention unit 201 for correspondence with the utterance content columns U1a→U2a→U3a→U4a→□□, U1a→U2a→U3a→U4b→□□, and so on, obtained by the utterance content history storage part 302 through the process of bringing together past utterance contents of the same type.

As an example, the operation when the customer has just spoken the utterance No. 3 in the example above will be described below. The utterance contents of the utterance Nos. 1 to 3, which are currently retained temporarily in the utterance content temporary retention unit 201, are respectively of the same type as the utterance contents U1a to U3a in FIG. 24. All the utterance content columns which have been brought together into U1a to U3a correspond to the first to third utterance contents of the current utterance column.

The candidate next utterance content extraction unit 205 then acquires the utterance contents U4a and U4b from the past utterance content column. These utterance contents are located next to U3a, which is the utterance content corresponding to the utterance content of the newest utterance No. 3. The candidate next utterance content extraction unit 205 extracts the utterance contents U4a and U4b as the representative candidate next utterance contents, because they are both the results of bringing together 50% of the candidate next utterance contents corresponding to the utterance content of the newest utterance No. 3.

Of these, only U4a is the candidate next utterance content with a high correlation with the utterance content column evaluation value. The next utterance content information output unit 213, therefore, outputs the candidate next utterance content U4a, along with the information indicating withdrawal of cancellation as the typical result of interaction corresponding to U4a.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, while the first to fifth exemplary embodiments have been described as the exemplary embodiments of the present invention, the exemplary embodiments are not limited to these but can be any combination of two or more of the first to fifth exemplary embodiments.

The first exemplary object of the present invention is achieved by presenting assistance information to a receptionist if all the conditions associated with such assistance information are satisfied for the first time.

The first exemplary object of the present invention can be achieved because candidate interaction contents for the next interaction to the current one are presented to the receptionist.

The second exemplary object of the present invention can be achieved because all reference information, which consists of past interaction contents and information referenced by all receptionists during the course of these interactions, is stored and because the receptionist is presented with the part of the reference information which corresponds to the current interaction content.

The third object of the present invention can be achieved because the receptionist is presented in advance with an interaction content which is expected to lead to a desirable interaction result, by previously storing past interaction contents and their correlations with interaction results and then presenting a past interaction content which corresponds to the current one and its correlation with an interaction result.

The present invention achieves the following effects.

Firstly, assistance information to be presented to a receptionist and a presentation timing therefor can be finely controlled according to the progress of an interaction. As a result, excessive information can be prevented from being presented to the receptionist. In addition, it becomes unnecessary for the receptionist to keep reading assistance information as the interaction progresses.

This is because whether or not assistance information should be presented can be determined according to the presence or lack of a specific interaction content among the interaction contents heretofore between the receptionist and the customer.

Secondly, assistance can be provided to a receptionist without needing to previously prepare assistance information. As a result, efforts to previously prepare assistance information can be saved.

This is because past interaction contents are recorded and, if an interaction content which corresponds to the content of the current interaction between a receptionist and a customer exists among the past interaction contents thus recorded, an interaction content recorded next to the corresponding past interaction content is presented to the receptionist as a candidate interaction content for the next interaction.

Thirdly, a receptionist can be presented with assistance information at the timing when he/she needs the assistance information because reference information indicating which data was referenced by receptionists during past interactions is recorded and a piece of reference information which corresponds to the current interaction content is presented to the receptionist as assistance information.

Finally, assistance can be provided to a receptionist who is interacting with a customer for a specific purpose because past interaction contents are associated with their interaction results and, when the current interaction which corresponds to a past interaction content begins, the receptionist is presented with the result of the past interaction in advance.

### INCORPORATION BY REFERENCE

This application is based upon and claims the benefit of priority from Japanese patent application No. 2005-046874, filed on Feb. 23, 2005, the disclosure of which is incorporated herein in its entirety by reference.

### INDUSTRIAL APPLICABILITY

The present invention can be applied to applications for assisting call center receptionists who serve customers by telephone or electronic bulletin board or chat system. The present invention can also be applied to assistance applications for storefront receptionists who serve customers through face-to-face interactions.

1-57. (canceled)

58. An interaction assistance system which assists a receptionist in interacting with a customer, comprising:
an assistance information storage server which stores information including at least the contents of responses made by receptionists to customers in the past as prior knowledge to help the receptionist perform an interaction with the customer smoothly; and
an assistance information presentation apparatus which, when the receptionist interacts with the customer, analyzes the content of the response between the receptionist and the customer, acquires the prior knowledge associated with the content of the response from said assistance information storage server, and presents to the receptionist such knowledge as assistance information to assist the receptionist in responding to the customer.

59. The interaction assistance system of claim 58, wherein said prior knowledge is the interaction contents of responses made by receptionists to customers in the past.

60. The interaction assistance system of claim 58, wherein said assistance information is knowledge acquired from the content of responses made by receptionist to customers in the past.

61. The interaction assistance system of claim 58, wherein said prior knowledge includes the information referenced by receptionist when responding to customers in the past.

62. An interaction assistance system which assists a receptionist in interacting with a customer via a communication line, comprising:
an assistance information presentation apparatus which acquires the information associated with the content of the interaction currently being performed with said customer via said communication line from accumulated information which indicates the contents of interactions performed between said customer and said receptionist, and presents such information to said receptionist as assistance information to assist said receptionist in interacting with said customer.

63. An interaction assistance system which assists a receptionist in interacting with a customer via a communication line, comprising:
an assistance information storage server which stores assistance information to assist said receptionist in interacting with said customer in association with predetermined presentation conditions; and
an assistance information presentation apparatus which, when the content of the interaction being performed with said customer via said communication line satisfies said presentation conditions, acquires said assistance information which corresponds to said presentation conditions from said assistance information storage server, and presents such information to said receptionist.

64. The interaction assistance system of claim 63, wherein said assistance information presentation apparatus acquires said assistance information which corresponds to said presentation conditions from said assistance information storage server and presents such information to the receptionist, only when the content of said response satisfies all of said presentation conditions for the first time.

65. An interaction assistance system which assists a receptionist in interacting with a customer via a communication line, comprising:
an assistance information storage server which, as assistance information to assist said receptionist in interacting with said customer, stores and accumulates the content of the interaction performed between said receptionist and said customer via said communication line, in association with order information which indicates the order relation within said interaction content; and
an assistance information presentation apparatus which, based on said content of the interaction which is currently being performed with said customer via said communication line, acquires from said assistance information storage server said content of the interaction indicated by said order information as a candidate of the interaction content to be spoken following said content of the interaction which is currently being performed, and presents such content to said receptionist as said assistance information.

66. An interaction assistance system which assists a receptionist in interacting with a customer via a communication line, comprising:
an assistance information storage server which, as assistance information to assist said receptionist in interacting with said customer, stores the reference information referenced by said receptionist as of the time of said content of the interaction with said customer, in association with said content of the interaction; and
an assistance information presentation apparatus which acquires from said assistance information storage server said reference information associated with the content of the interaction which is currently being performed with said customer via said communication line, and presents such information to said receptionist as said assistance information.

67. The interaction assistance system of claim 66, wherein said assistance information presentation apparatus presents said reference information to said receptionist as assistance information as of the time when said content of the interaction is currently being performed with said customer via said communication line.

68. The interaction assistance system of claim 66, wherein said assistance information storage server further stores, as assistance information to assist said receptionist in interacting with said customer, the content of the interaction performed between said receptionist and said customer via said communication line, in association with order information which indicates the order relation within said interaction content; and
said assistance information presentation apparatus, as said reference information associated with the content of the interaction which is currently being performed with said customer via said communication line, and based on said content of the interaction which is currently being performed with said customer, acquires from said assistance information storage server said reference information associated with said content of the interaction indicated by said order information as a candidate of the interaction content to be spoken following said content of the interaction which is currently being performed, and presents such content to said receptionist as said assistance information.

69. An interaction assistance system which assists a receptionist in interacting with a customer via a communication line, comprising:
an assistance information storage server which, as assistance information to assist said receptionist in interacting with said customer, stores the interaction evaluation information which indicates the result of said interaction produced by the content of the interaction performed between said receptionist and said customer, in association with said content of the interaction; and
an assistance information presentation apparatus which acquires from said assistance information storage server said interaction evaluation information associated with the content of the interaction which is currently being performed with said customer via said communication line, and presents such information to said receptionist as assistance information.

70. The interaction assistance system of claim 69, wherein said assistance information presentation apparatus presents said interaction evaluation information to said receptionist as assistance information if there is a high correlation between said interaction evaluation information and the result of said interaction.

71. The interaction assistance system of claim 69, wherein said assistance information storage server further stores, as assistance information to assist said receptionist in interacting with said customer, the content of the interaction performed between said receptionist and said customer via said communication line in association with order information which indicates the order relation within said interaction content; and
said assistance information presentation apparatus, as said interaction evaluation information associated with the content of the interaction which is currently being performed with said customer via said communication line, and based on said content of the interaction which is currently being performed, acquires from said assistance information storage server said content of the interaction indicated by said order information as a candidate of the interaction content to be spoken following said content of said interaction and said interaction evaluation information which is associated with this content of the interaction, and presents such content and such information to said receptionist as said assistance information.

72. The interaction assistance system of claim 62, comprising an interaction content temporary retention apparatus which temporarily retains the predetermined range of a content sequence within an interaction which is currently being performed between said receptionist and said customer via said communication line, and wherein
said assistance information presentation apparatus presents to said receptionist said assistance information acquired based on said interaction content which is being retained by said interaction content temporary retention apparatus.

73. An interaction assistance apparatus which assists a receptionist in interacting with a customer via a communication line, comprising:
an assistance information presentation unit which acquires the information associated with the content of the interaction currently being performed with said customer via said communication line from accumulated information which indicates the contents of interactions performed between said customer and said receptionist, and presents such information to said receptionist as assistance information to assist said receptionist in interacting with said customer.

74. An interaction assistance apparatus which assists a receptionist in interacting with a customer via a communication line, comprising:
an assistance information storage unit which stores assistance information to assist said receptionist in interacting with said customer in association with predetermined presentation conditions; and
an assistance information presentation unit which, when the content of the interaction being performed with said customer via said communication line satisfies said presentation conditions, acquires said assistance information which corresponds to said presentation conditions from said assistance information storage unit, and presents such information to said receptionist.

75. The interaction assistance apparatus of claim 74, wherein said assistance information presentation unit acquires said assistance information which corresponds to said presentation conditions from said assistance information storage unit and presents such information to the receptionist, only when the content of said response satisfies all of said presentation conditions for the first time.

76. An interaction assistance apparatus which assists a receptionist in interacting with a customer via a communication line, comprising:
an assistance information storage unit which, as assistance information to assist said receptionist in interacting with said customer, stores and accumulates the content of the interaction performed between said receptionist and said customer via said communication line in association with order information which indicates the order relation within said interaction content; and
an assistance information presentation unit which, based on said content of the interaction which is currently being performed with said customer via said communication line, acquires from said assistance information storage unit said content of the interaction indicated by said order information as a candidate of the interaction content to be spoken following said content of the interaction which is currently being performed, and presents such content to said receptionist as said assistance information.

77. An interaction assistance apparatus which assists a receptionist in interacting with a customer via a communication line, comprising:
an assistance information storage unit which, as assistance information to assist said receptionist in interacting with said customer, stores the reference information referenced by said receptionist as of the time of said content of the interaction with said customer, in association with said content of the interaction; and
an assistance information presentation unit which acquires from said assistance information storage unit said reference information associated with the content of the interaction which is currently being performed with said customer via said communication line, and presents such information to said receptionist as said assistance information.

78. The interaction assistance apparatus of claim 77, wherein said assistance information presentation unit presents said reference information to said receptionist as assistance information as of the time when said content of the interaction is currently being performed with said customer via said communication line.

79. The interaction assistance apparatus of claim 77, wherein said assistance information storage unit further stores, as assistance information to assist said receptionist in interacting with said customer, the content of the interaction performed between said receptionist and said customer via said communication line in association with order information which indicates the order relation within said interaction content; and
said assistance information presentation unit, as said reference information associated with the content of the interaction which is currently being performed with said customer via said communication line, and based on said content of the interaction which is currently being performed with said customer, acquires from said assistance information storage unit said reference information associated with said content of the interaction indicated by said order information as a candidate of the interaction content to be spoken following said content of the interaction, and presents such content to said receptionist as said assistance information.

80. An interaction assistance apparatus which assists a receptionist in interacting with a customer via a communication line, comprising:
an assistance information storage unit which stores, as assistance information to assist said receptionist in interacting with said customer, the interaction evaluation information which indicates the result of said interaction produced by the content of the interaction performed between said receptionist and said customer in association with said content of the interaction; and
an assistance information presentation unit which acquires from said assistance information storage unit said interaction evaluation information associated with the content of the interaction which is currently being performed with said customer via said communication line, and presents such information to said receptionist as said assistance information.

81. The interaction assistance apparatus of claim 80, wherein said assistance information presentation unit presents said interaction evaluation information to said receptionist as assistance information if there is a high correlation between said interaction evaluation information and the result of said interaction.

82. The interaction assistance apparatus of claim 80, wherein said assistance information storage unit further stores, as assistance information to assist said receptionist in interacting with said customer, the content of the interaction performed between said receptionist and said customer via said communication line in association with order information which indicates the order relation within said interaction content; and
said assistance information presentation unit, as said interaction evaluation information associated with the content of the interaction which is currently being performed with said customer via said communication line, and based on said content of the interaction which is currently being performed, acquires from said assistance information storage unit said content of the interaction indicated by said order information as a candidate of the interaction content to be spoken following said content of said interaction and said interaction evaluation information which is associated with this content of the interaction, and presents such content and such information to said receptionist as said association information.

83. The interaction assistance apparatus of claim 73, comprising an interaction content temporary retention unit which temporarily retains the predetermined range of a content sequence within an interaction which is currently being performed between said receptionist and said customer via said communication line, and wherein
said assistance information presentation unit presents to said receptionist said assistance information acquired based on said interaction content which is being retained by said interaction content temporary retention unit.

84. An interaction assistance method which assists a receptionist in interacting with a customer, comprising:
an assistance information storage step which stores information including at least the contents of responses made by receptionists to customers in the past as prior knowledge to help the receptionist perform an interaction with the customer smoothly; and
an assistance information presentation step which, when a receptionist interacts with a customer, analyzes the content of the response between the receptionist and the customer, acquires the prior knowledge associated with the content of the response from said assistance information storage server, and presents to the receptionist such knowledge as assistance information to assist the receptionist in responding to the customer.

85. The interaction assistance method of claim 84, wherein said prior knowledge is the interaction contents of responses made by receptionists to customers in the past.

86. The interaction assistance method of claim 84, wherein said assistance information is knowledge acquired from the contents of responses made by receptionists to customers in the past.

87. The interaction assistance method of claim 84, wherein said prior knowledge includes the information referenced by receptionists when responding to customers in the past.

88. An interaction assistance method which assists a receptionist in interacting with a customer via a communication line, comprising:
an assistance information presentation step which acquires the information associated with the content of the interaction currently being performed with said customer via said communication line from accumulated information which indicates the contents of interactions performed between said customer and said receptionist, and presents such information to said receptionist as assistance information to assist said receptionist in interacting with said customer.

89. An interaction assistance method which assists a receptionist in interacting with a customer via a communication line, comprising:
an assistance information storage step which stores assistance information to assist said receptionist in interacting with said customer in association with predetermined presentation conditions; and
an assistance information presentation step which, only when the content of the interaction being performed with said customer via said communication line satisfies said presentation conditions for the first time, acquires said assistance information which corresponds to said presentation conditions in said assistance information storage step, and presents such information to said receptionist.

90. An interaction assistance method which assists a receptionist in interacting with a customer via a communication line, comprising:
an assistance information storage step which stores and accumulates, as assistance information to assist said receptionist in interacting with said customer, the content of the interaction performed between said receptionist and said customer via said communication line in association with order information which indicates the order relation within said interaction content; and
an assistance information presentation step which, based on said content of the interaction which is currently being performed with said customer via said communication line, acquires said content of the interaction indicated by said order information as a candidate of the interaction content to be spoken following said content of the interaction which is currently being performed, and presents such content to said receptionist as said assistance information as of the time when the content of said interaction which is currently being performed with said customer via said communication line.

91. An interaction assistance method which assists a receptionist in interacting with a customer via a communication line, comprising:
an assistance information storage step which stores, as assistance information to assist said receptionist in interacting with said customer, the reference information referenced by said receptionist as of the time of said content of the interaction with said customer, in association with said content of the interaction; and
an assistance information presentation step which acquires said reference information associated with the content of the interaction which is currently being performed with said customer via said communication line, and presents such information to said receptionist as assistance information as of the time when the content of said interaction which is currently being performed with said customer via said communication line.

92. An interaction assistance method which assists a receptionist in interacting with a customer via a communication line, comprising:
an assistance information storage step which, as assistance information to assist said receptionist in interacting with said customer, stores the interaction evaluation information which indicates the result of said interaction produced by the content of the interaction performed between said receptionist and said customer in association with said content of the interaction; and
an assistance information presentation step which acquires said interaction evaluation information associated with the content of the interaction which is currently being performed with said customer via said communication line, and presents such information to said receptionist as assistance information as of the time when the content of said interaction which is currently being performed with said customer via said communication line.

93. The interaction assistance method of claim 92, wherein said assistance information presentation step presents said interaction evaluation information to said receptionist as assistance information if there is a high correlation between said interaction evaluation information and the result of said interaction.

94. An interaction assistance program which assists a receptionist in interacting with a customer by being executed on a computer processing apparatus, comprising:
causing said computer processing apparatus to execute
an assistance information storage function which stores information including at least the contents of responses made by receptionists to customers in the past as prior knowledge to help the receptionist perform an interaction with a customer smoothly; and
an assistance information presentation function which, when a receptionist interacts with a customer, analyzes the content of the response between the receptionist and the customer, acquires the prior knowledge associated with the content of the response from said assistance information storage server, and presents to the receptionist such knowledge as assistance information to assist the receptionist in responding to the customer.

95. The interaction assistance program of claim 94, wherein said prior knowledge is the interaction contents of responses made by receptionists to customers in the past.

96. The interaction assistance program of claim 94, wherein said assistance information is knowledge acquired from the contents of responses made by receptionists to customers in the past.

97. The interaction assistance program of claim 94, wherein said prior knowledge includes the information referenced by receptionists when responding to customers in the past.

98. An interaction assistance program which assists a receptionist in interacting with a customer via a communication line by being executed on a computer processing apparatus, comprising:
causing said computer processing apparatus to execute
an assistance information presentation function which acquires the information associated with the content of the interaction currently being performed with said customer via said communication line from accumulated information which indicates the contents of interactions performed between said customer and said receptionist, and presents such information to said receptionist as assistance information to assist said receptionist in interacting with said customer.

99. An interaction assistance program which assists a receptionist in interacting with a customer via a communication line by being executed on a computer processing apparatus, comprising:
causing said computer processing apparatus to execute
an assistance information storage function which stores assistance information to assist said receptionist in interacting with said customer in association with predetermined presentation conditions; and
an assistance information presentation function which, when the content of the interaction being performed with said customer via said communication line satisfies said presentation conditions, acquires said assistance information which corresponds to said presentation conditions, and presents such information to said receptionist.

100. The interaction assistance program of claim 99, wherein said assistance information presentation function acquires said assistance information which corresponds to said presentation conditions and presents such information, only when the content of said response satisfies all of said presentation conditions for the first time.

101. An interaction assistance program which assists a receptionist in interacting with a customer via a communication line by being executed on a computer processing apparatus, comprising:
causing said computer processing apparatus to execute
an assistance information storage function which stores and accumulates, as assistance information to assist said receptionist in interacting with said customer, the content of the interaction performed between said receptionist and said customer via said communication line in association with order information which indicates the order relation within said interaction content; and
an assistance information presentation function which, based on said content of the interaction which is currently being performed with said customer via said communication line, acquires said content of the interaction indicated by said order information as a candidate of the interaction content to be spoken following said content of the interaction which is currently being performed, and presents such content to said receptionist as said assistance information.

102. An interaction assistance program which assists a receptionist in interacting with a customer via a communication line by being executed on a computer processing apparatus, comprising:
causing said computer processing apparatus to execute
an assistance information storage function which, as assistance information to assist said receptionist in interacting with said customer, stores the reference information referenced by said receptionist as of the time of said content of the interaction with said customer, in association with said content of the interaction; and
an assistance information presentation function which acquires said reference information associated with the content of the interaction which is currently being performed with said customer via said communication line, and presents such information to said receptionist as said assistance information.

103. The interaction assistance program of claim 102, wherein said assistance information presentation function presents said reference information to said receptionist as assistance information as of the time when said content of the interaction is currently being performed with said customer via said communication line.

104. The interaction assistance program of claim 101, wherein said assistance information storage function further stores, as assistance information to assist said receptionist in interacting with said customer, the content of the interaction performed between said receptionist and said customer via said communication line in association with order information which indicates the order relation within said interaction content; and
said assistance information presentation function, as said reference information associated with the content of the interaction which is currently being performed with said customer via said communication line, and based on said content of the interaction which is currently being performed with said customer, acquires the reference information associated with said content of the interaction indicated by said order information as a candidate of the interaction content to be spoken following said content of the interaction which is currently being performed, and presents such content to said receptionist as said assistance information.

105. An interaction assistance program which assists a receptionist in interacting with a customer via a communication line by being executed on a computer processing apparatus, comprising:
causing said computer processing apparatus to execute
an assistance information storage function which stores, as assistance information to assist said receptionist in interacting with said customer, the interaction evaluation information which indicates the result of said interaction produced by the content of the interaction performed between said receptionist and said customer in association with said content of the interaction; and
an assistance information presentation function which acquires said interaction evaluation information associated with the content of the interaction which is currently being performed with said customer via said communication line, and presents such information to said receptionist as assistance information.

106. The interaction assistance program of claim 105, wherein said assistance information presentation function presents said interaction evaluation information to said receptionist as assistance information if there is a high correlation between said interaction evaluation information and the result of said interaction.

107. The interaction assistance program of claim 105, wherein said assistance information storage function further stores, as assistance information to assist said receptionist in interacting with said customer, the content of the interaction performed between said receptionist and said customer via said communication line in association with order information which indicates the order relation within said interaction content; and
said assistance information presentation function, as said interaction evaluation information associated with the content of the interaction which is currently being performed with said customer via said communication line, and based on said content of the interaction which is currently being performed, acquires said content of the interaction indicated by said order information and said interaction evaluation information which is associated with this content of interaction as a candidate of the interaction content to be spoken following said content of the interaction which is currently being performed, and presents such content to said receptionist as said assistance information.

108. The interaction assistance program of claim 98, comprising an interaction content temporary retention function which temporarily retains the predetermined range of a content sequence within an interaction which is currently being performed between said receptionist and said customer via said communication line, and wherein
said assistance information presentation function presents to said receptionist said assistance information acquired based on said interaction content which is being retained by said interaction content temporary retention function.
